(19) United States
(12) Patent Application Publication
(10) Pub. No.: US 2026/0149521 A1
(43) Pub. Date: May 28, 2026

(54) Clock Synchronization Between Access Networks Through Core Network

(71) Applicant: Cisco Technology, Inc., San Jose, CA (US)

(72) Inventors: Sreejith Avikkal, Kanata (CA); Geetharthi Gopalan, Kanata (CA); Jaganbabu Rajamanickam, Kanata (CA); Madhan Sankaranarayanan, Chennai (IN)

(21) Appl. No.: 18/957,806

(22) Filed: Nov. 24, 2024

(51) Int. Cl. H04J 3/06

(52) U.S. Cl. CPC H04J 3/0673; H04J 3/0664

(57) ABSTRACT

Devices, systems, methods, and processes that facilitate clock synchronization between access networks connected through a core network are described herein. Typically, clock synchronization over a core network is prone to jitters and wander. Therefore, the present disclosure provides clock synchronization using edge devices for stateless clock propagation from one access network to another via a core network. The core network acts as a transparent node where latency is calculated by a difference between transmit and receive timestamps of a timing packet. An ingress edge device may capture, in the timing packet, the receive timestamp of receiving the timing packet and forward the timing packet to an egress edge device. The egress edge device may update a correction field of the timing packet based on a difference between the receive timestamp at the ingress edge device and a transmit timestamp at the egress edge device and forward the timing packet.

The present disclosure relates to network management. More particularly, the present disclosure relates to clock synchronization between access networks through a core network.

### BACKGROUND

Clock synchronization across different networks is an important aspect in telecommunications and computer networks. Clock synchronization ensures that network devices operating in different access networks, mobile networks (such as 4G/5G networks), distributed systems, or the like operate with the same time reference. Accurate clock synchronization is important for proper functioning, specifically for time-sensitive applications such as voice, video, and real-time data processing. Further, various new age applications such as high-frequency trading, power grid monitoring, or the like require high-precision clocks and are sensitive to jitter which may compromise the accuracy of these applications. There are various network synchronization protocols developed to provide synchronization, for example, plesiochronous digital hierarchy (PDH), synchronous digital hierarchy (SDH), network time protocol (NTP), precision time protocol (PTP), and various GNSS-based synchronization techniques.

However, synchronization between different access networks (for example, access networks of same company operational in different buildings) over a core network can be challenging, as the core network tends to introduce significant jitter and wander. Moreover, timing packets initiated from the access networks are generally encapsulated by edge devices located at the boundary of the core network using various transport services. Such encapsulation may hinder intermediate nodes within the core network from recognizing and processing the timing packets originating from the access networks, further exacerbating the synchronization issue.

### SUMMARY OF THE DISCLOSURE

Systems and methods for stateless clock synchronization between access networks connected through a core network in accordance with embodiments of the disclosure are described herein. In many embodiments, an ingress network device, comprising a processor, one or more receive ports, one or more transmit ports, and a memory communicatively coupled to the processor, is provided. The memory comprises a synchronization logic that is configured to receive a timing packet at a receive port of the one or more receive ports, capture, in the timing packet, a receive timestamp of receiving the timing packet, add an encapsulation to the timing packet, and forward the timing packet via a transmit port of the one or more transmit ports.

In a number of embodiments, the timing packet comprises a timing value and a correction field.

In a variety of embodiments, capturing the receive timestamp in the timing packet comprises modifying an existing value of the correction field based on the receive timestamp.

In more embodiments, the existing value of the correction field is modified to indicate a difference of the receive timestamp and the existing value of the correction field.

In further embodiments, the receive timestamp is captured in the timing packet prior to encapsulating the timing packet.

In additional embodiments, capturing the receive timestamp in the timing packet comprises assigning metadata to the timing packet. The metadata is configured to indicate the receive timestamp.

In still more embodiments, the metadata is further configured to indicate an acceptable threshold range that defines a maximum time difference allowed between the ingress network device and an egress network device.

In still further embodiments, the receive port is associated with a relay state port property.

In still additional embodiments, the synchronization logic is further configured to determine whether the relay state port property is enabled.

In yet more embodiments, the timing packet is forwarded in response to determining that the relay state port property is enabled.

In still yet more embodiments, the timing packet comprises a relay identifier that is configured to indicate at least one of a source entity associated with the timing packet or a source port that provided the timing packet to the receive port.

In many further embodiments, the synchronization logic is further configured to determine whether the relay identifier has a preset value.

In many additional embodiments, the timing packet is forwarded in response to determining that the relay identifier has the preset value.

In still yet further embodiments, the relay identifier is propagated as one of a part of the encapsulation or within a payload of the timing packet.

In still yet additional embodiments, the ingress network device corresponds to an ingress provider edge device in a core network.

In several embodiments, an egress network device, comprising a processor, one or more transmit ports, and a memory communicatively coupled to the processor, is provided. The memory comprises a synchronization logic that is configured to receive an encapsulated timing packet comprising a timing value and a correction field, decapsulate the timing packet, update the correction field based on an existing value of the correction field and a transmit timestamp of the timing packet from the egress network device, and forward, at the transmit timestamp, the timing packet with the updated correction field via a transmit port of the one or more transmit ports.

In several more embodiments, the correction field is further updated based on a receive timestamp of the timing packet at an ingress network device.

In numerous embodiments, the updated correction field is configured to indicate a timing delay associated with a core network that comprises the egress network device and the ingress network device.

In numerous additional embodiments, prior to forwarding the timing packet, the synchronization logic is further configured to determine a difference between the transmit timestamp and the receive timestamp, compare the determined difference with an acceptable threshold range, and permit forwarding of the timing packet based on the determined difference being within the acceptable threshold range.

In further additional embodiments, a method for time synchronization, comprising receiving a timing packet at a receive port of an ingress network device, capturing, in the timing packet, a receive timestamp of the timing packet at the receive port, adding an encapsulation to the timing packet, and transmitting the timing packet via a transmit port of the ingress network device, is provided.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration depicting a network environment for clock synchronization across a plurality of access networks connected through a core network in accordance with various embodiments of the disclosure;

FIG. 2 is a conceptual illustration depicting a network environment for clock synchronization across a plurality of access networks using a relay state port property in accordance with various embodiments of the disclosure;

FIG. 3 is a conceptual illustration depicting a network environment for clock synchronization across a plurality of access networks using a relay identifier in accordance with various embodiments of the disclosure;

FIG. 4 is a conceptual diagram illustrating message flow between a source device and a destination device via a core network in accordance with various embodiments of the disclosure;

FIG. 5 is a conceptual diagram illustrating an ingress network device and an egress network device that implements a clock synchronization process in accordance with various embodiments of the disclosure;

FIG. 6 is a flowchart showing a process for forwarding a timing packet by an ingress network device in accordance with various embodiments of the disclosure;

FIG. 7 is a flowchart showing a process for updating a correction field of a timing packet by an ingress network device in accordance with various embodiments of the disclosure;

FIG. 8 is a flowchart showing a process for assigning metadata to a timing packet by an ingress network device in accordance with various embodiments of the disclosure;

FIG. 9 is a flowchart showing a process for forwarding a timing packet by an ingress network device using relay state property in accordance with various embodiments of the disclosure;

FIG. 10 is a flowchart showing a process for forwarding a timing packet by an ingress network device using relay identifier in accordance with various embodiments of the disclosure;

FIG. 11 is a flowchart showing a process for receiving a timing packet by an egress network device in accordance with various embodiments of the disclosure;

FIG. 12 is a flowchart showing a process for receiving a timing packet by an egress network device in accordance with various embodiments of the disclosure; and

FIG. 13 is a conceptual block diagram of a device suitable for configuration with a synchronization logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that facilitate stateless clock synchronization between access networks connected through a core network. Typically, in telecommunications, digital communication networks, etc., synchronization plays a vital role in maintaining the accuracy, reliability, and efficiency of data transfer. Specifically for time-sensitive applications (such as voice, video, real-time data processing, etc.) proper clock synchronization is required to ensure that packets and frames are transmitted and received at the right times. Without proper clock synchronization, packets or frames may arrive too early, too late, or may even overlap resulting in loss of data or data corruption. Proper clock synchronization may also ensure that data buffers neither overflow nor underflow. Further, applications related to 5G networks, high-frequency trading, power grid monitoring, or the like may require high-precision clocks. Such high-precision clocks are generally sensitive to jitter, which may affect the accuracy of the application.

Currently, synchronization between different access networks over a core network is difficult to achieve, as the core network introduces significant jitter and wander. Here the different access networks can also belong to the same network domain. For example, an enterprise domain network can span across multiple buildings, spread across a campus or different geographical regions, or the like. These access networks may be interconnected through the core network or may be connected to other access networks or to the Internet via the core network. Since the core network introduces significant jitter and wander to clock or timing packets transmitted by the access networks, synchronization between different access networks becomes challenging.

Moreover, packets initiated from the access networks are encapsulated by edge devices located at the boundary of the core network using various transport services such as Virtual Extensible Local Area Network (VxLAN), Multiprotocol Label Switching (MPLS), Segment Routing over IPv6 (SRv6), Generic Routing Encapsulation (GRE) Tunnel, etc. An edge device may refer to a network device that resides between the access network (where end-user devices like computers, phones, IoT devices, etc. connect) and the core network. The edge devices may provide the point of entry and exit for traffic moving from end-user devices into the wider enterprise network and vice versa. Examples of the edge devices can include, but not limited to, switches, access points (APs), routers, firewalls, gateways, or the like. The edge devices may encapsulate timing packets, originating from the access networks, by including necessary headers and data. Thus, ensuring that these timing packets are transmitted properly to their intended destination. Due to the encapsulation added by the edge devices, intermediate nodes within the core network are unable to recognize and process the timing packets, further exacerbating the synchronization issue.

To overcome these issues, the present disclosure provides a solution implemented at edge devices for transparent and stateless clock propagation from one access network to another access network via a core network. The edge devices may refer to ingress network devices or egress network devices. Within a network domain (such as an enterprise network spanning multiple buildings), an ingress network device may refer to a network device that is located between an access network and a core network, and may serve as an entry point for traffic entering into the core network from the access network. In a similar manner, an egress network device may refer to a network device that is located between a core network and an access network, and may serve as an exit point for the traffic leaving the core network and entering the access network. Depending upon the flow of the traffic from or to an access network, an edge device coupled to the access network can function as an ingress network device or an egress network device. In other words, the edge device can manage both ingress (incoming) and egress (outgoing) traffic and may have ingress and egress ports.

In a number of embodiments, an ingress network device may be located at a boundary between a first access network and a core network. The ingress network device may include one or more receive ports, of which at least one receive port is communicatively coupled to the first access network. The ingress network device may receive a timing packet at the receive port coupled to the first access network. In a variety of embodiments, the timing packet may be initiated by a clock source within the first access network. For example, certain devices in the first access network, such as routers, switches, or base stations, can be equipped with a GPS receiver, and thus, may receive highly accurate timing information from GPS satellites. Such devices can act as a local master clock for the first access network and may generate and transmit the timing packet. The timing packet may refer to Network Time Protocol (NTP) packet, Precision Time Protocol (PTP) packet, or any other time synchronization protocol packet. For example, in the context of PTP, the timing packet can correspond to a Sync message, Delay Request message, or the like. In more embodiments, the timing packet may comprise a timing value and a correction field, in addition to other protocol specific information. The timing value may represent receive or transmit timestamps associated with a source device. For example, the source device may correspond to a master clock for the first access network, and may transmit the timing packet. The correction field in the timing packet may be utilized to account for various delays, such as processing delay, transmission time, queuing delay, or the like, encountered by the timing packet as the timing packet travels through the network. In other words, a correction field value may be representative of cumulative delay the timing packet has encountered after it was transmitted by the source device. In addition to the timing value, the cumulative delay information in the correction field may be utilized by a destination network device to correct its local clock with high precision, ensuring accurate time synchronization across the network.

In more embodiments, the ingress network device may capture, in the timing packet, a receive timestamp of receiving the timing packet at the receive port. For example, the ingress network device may modify an existing value of the correction field to capture the receive timestamp of the timing packet at the ingress network device. The ingress network device may modify the existing value of the correction field based on the receive timestamp. The existing value of the correction field may be modified to indicate a difference of the receive timestamp and the existing value of the correction field. In another example, the ingress network device may capture the receive timestamp of receiving the timing packet in metadata and embed the metadata in the timing packet. The metadata may be configured to indicate the receive timestamp of the timing packet at the ingress network device, and can additionally indicate an acceptable threshold range that defines a maximum time difference allowed between the ingress network device and an egress network device. In many embodiments, the ingress network device may further add an encapsulation to the timing packet and forward the encapsulated timing packet. Thus, the encapsulated timing packet with the captured receive timestamp, is propagated via one or more intermediate nodes of the core network till the encapsulated timing packet reaches the egress network device.

In still more embodiments, the receive port of the ingress network device may be associated with a relay state property. The relay state property of a port may indicate how a port should behave while forwarding or handling timing packets. In other words, the relay state property may indicate specific operational modes of a network device. In still further embodiments, if the relay state port property of the receive port of the ingress network device is enabled, the timing packet may update the correction field with the difference of the receive timestamp of the timing packet and the existing value of the correction field. In still further embodiments, if the relay state port property of the receive port of the ingress network device is enabled, the timing packet may be updated with a metadata indicating the receive timestamp of the timing packet. However, in a case where the ingress network device determines that the relay state port property of the receive port is disabled, the ingress network device may discard or drop the timing packet.

In still additional embodiments, the timing packet may include a relay identifier configured to indicate at least one of a source entity associated with the timing packet or a source port that provided the timing packet to the receive port. A relay identifier may refer to a unique identifier or marker within a timing packet that can be utilized to identify a network device (such as a switch, a router, an AP, or the like) that has forwarded or relayed the timing packet to the ingress network device. The relay identifier may be utilized to track the flow of the timing packet through the first access network. In yet more embodiments, the ingress network device may determine whether the relay identifier included in the timing packet has a preset value. Based on the relay identifier having the preset value, in still yet more embodiments, the ingress network device may forward the timing packet, else the ingress network device may discard the timing packet. In many further embodiments, when the ingress network device forwards the encapsulated timing packet, the relay identifier may be propagated as one of a part of the encapsulation or within a payload of the timing packet via the core network.

In many additional embodiments, the egress network device may be located at a boundary between the core network and a second access network. The egress network device may include one or more receive ports, of which at least one receive port is communicatively coupled to the core network, and one or more transmit ports, of which at least one transmit port is communicatively coupled to the second access network. The egress network device may receive the encapsulated timing packet comprising the timing value and the correction field from the core network. The egress network device may decapsulate the timing packet. In still yet further embodiments, the egress network device may update the correction field based on an existing value of the correction field and a transmit timestamp of the timing packet from the egress network device. In an example where the ingress network device modified the correction field with the difference of the receive timestamp and the original value of the correction field, the egress network device may update the correction field with a value obtained by subtracting the existing value of the correction field from the transmit timestamp of the egress network device. In further examples where the receive timestamp is captured in the metadata, the egress network device may update the correction field by adding to the existing value of the correction field, a difference between the receive timestamp of the ingress network device and the transmit timestamp of the egress network device. By updating the correction field, the egress network device captures a total delay experienced by the timing packet in the correction field. Thus, making the propagation of the timing packet via the core network transparent to the second access network. In still yet additional embodiments, the egress network device may forward, at the transmit timestamp, the timing packet with the updated correction field via the transmit port coupled to the second access network.

In several embodiments, the egress network device may determine the difference between the transmit timestamp and the receive timestamp of the timing packet. The egress network device may compare the determined difference with the acceptable threshold range. If the determined difference is within the acceptable threshold range, in several more embodiments, the egress network device may permit forwarding of the timing packet with the updated correction field to the second access network. However, if the time difference exceeds the acceptable threshold range, the egress network device may discard the timing packet to prevent incorrect clock synchronization data from propagating to the second access network. In still more embodiments, if the difference between the receive timestamp of the ingress network device and the transmit timestamp of the egress network device exceeds the acceptable threshold range, static or policy-defined actions may be executed by the egress network device for clock synchronization. In another example, the egress network device may trigger an alarm or notify network administrators about the out-of-range timing event.

Thus, the present disclosure presents a solution for stateless or transparent clock propagation from one access network to another via a core network. In other words, the ingress and egress network devices may be perceived as a single entity that functions as a transparent clock for access networks. Thus, the solution considers the core network as a transparent node where latency in the core network may be indicated in the correction field based on the difference between the transmit and receive timestamps of the timing packet in the core network.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

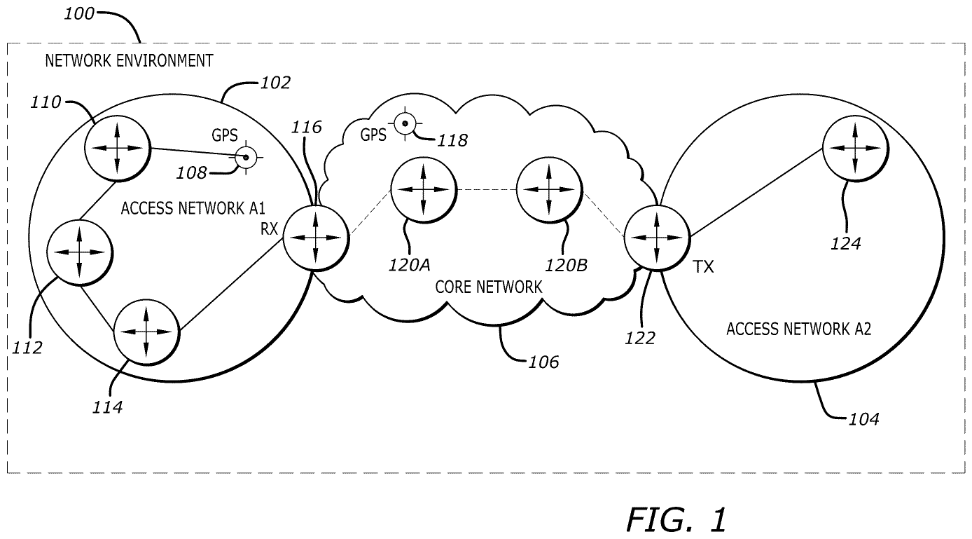

Referring to FIG. 1, a conceptual illustration depicting a network environment 100 for clock synchronization across a plurality of access networks connected through a core network in accordance with various embodiments of the disclosure is shown. In many embodiments, as depicted by FIG. 1, an access network A1 102 and an access network A2 104 may be connected to each other through a core network 106. In some examples, the access network A1 102 and the access network A2 104 may belong to the same network domain or timing domain. A network domain may refer to network devices (such as routers, access points, firewalls, switches, gateways, or the like) that belong to a unified network infrastructure and are centrally managed. The network domain may span across multiple buildings, such as different buildings within the same campus or geographically separated locations. Despite being physically separated, these network devices may operate under the same organizational policies, configurations, and security rules, creating a cohesive network domain that spans large geographical areas. In some other examples, the access network A1 102 and the access network A2 104 may belong to different network domains.

In a variety of embodiments, the access network A1 102 may include a clock source 108, for example, a Global Positioning System (GPS) clock source, and various access nodes 110, 112, 114. For example, network devices (such as routers, switches, access points, or the like) can be equipped with GPS receivers that obtain precise timing signals directly from satellites. These clock signals may be utilized to synchronize routers, switches, and other network equipment operating in the network environment 100. Other examples of the clock source may include internal clocks of network devices, network-based synchronization protocols, or the like. In more embodiments, the clock source 108 may be utilized by the access node 110 (such as routers, switches, APs, or the like) for clock synchronization. In additional embodiments, the access node 110 may function as a boundary clock. In an example scenario, the access node 110 may function as a boundary clock as per Precision Time Protocol (PTP), as defined in the IEEE 1588 standard. A boundary clock may refer to a network device that can act as both a master clock and a slave clock at an intermediate point in the network. When operating as a slave clock, the boundary clock may synchronize itself to the upstream grandmaster clock or another master clock in the network (such as the clock source 108 as depicted in FIG. 1). Once synchronized, the boundary clock may operate as a master clock for downstream devices, providing them with precise timing. The boundary clock may timestamp timing packets (such as the PTP packets) for the time taken by the timing packets while passing through the boundary clock.

In further embodiments, the access nodes 112, 114 may require to be time synchronized for managing network traffic, handovers, and maintaining the quality of time-sensitive applications. In an example scenario, the access node 112 may operate as a transparent clock. A transparent clock in a network, especially in networks using the PTP, may forward a timing packet while updating a correction field of the timing packet to account for the delay as the timing packet passes through the transparent clock. In other words, the transparent clock may not act as a clock itself, that is it may not participate in the master-slave clock hierarchy. Thus, the access node 112 may forward the timing packet to the access node 114, while updating the correction field of the timing packet. In still more embodiments, the access node 114 may function as another boundary clock or transparent clock.

In still further embodiments, the network environment 100 may further include a provider edge (PE) device 116, (for example, a router or a switch). The PE device 116 may act as an ingress network device, located at a boundary between the access network A1 102 and the core network 106. The PE device 116 may serve as an entry point for traffic entering into the core network 106 from the access network A1 102 or another external network. The traffic may include data packets, timing packets, management packets, control packets, or any other network related packets.

In still additional embodiments, the PE device 116 may receive a timing packet from the access node 114. The timing packet may include a timing value and a correction field, in addition to other protocol specific information. For example, in the context of PTP, the timing packet can correspond to a Sync message, Delay Request message, or the like. The timing value may represent a receive or transmit timestamp associated with a source device (for example, the access node 110). Further, the correction field in the timing packet may be utilized to account for various delays, such as processing delay, transmission time, queuing delay, or the like, encountered by the timing packet as the timing packet travels through the network. In other words, a correction field value may be representative of cumulative delay the timing packet has encountered after it was transmitted by the source device (for example, the access node 110). In addition to the timing value, the cumulative delay information in the correction field may be utilized by a destination network device to correct its local clock with high precision, ensuring accurate time synchronization with the access network A1 102.

In one or more embodiments, the PE device 116 may include one or more receive ports, of which at least one receive port (labeled as “RX” in FIG. 1) is communicatively coupled to the access node 114. The receive ports may refer to physical or logical interfaces through which packets may enter the PE device 116. The PE device 116 may receive the timing packet at the receive port RX coupled to the access node 114. In numerous additional embodiments, the timing packet can also be received by the PE device 116 from any other access node, for example, the access nodes 110, 112.

In yet more embodiments, the PE device 116 may capture, in the timing packet, a receive timestamp of receiving the timing packet at the receive port RX. In various embodiments, to capture the receive timestamp in the timing packet, the PE device 116 may modify an existing value of the correction field based on the receive timestamp. The PE device 116 may modify the existing value of the correction field to indicate a difference of the receive timestamp and the existing value of the correction field. In an example scenario, if an existing value of the correction field was “8 ns” and the PE device 116 received the timing packet at “12:56:00”, the PE device 116 may modify the existing value of the correction field with a value obtained by subtracting “8 ns” from the receive timestamp “12:56:00”. In many further embodiments, the PE device 116 may capture the receive timestamp in the timing packet by assigning (or adding or embedding) metadata to the timing packet. The metadata may be configured to indicate the receive timestamp of the timing packet. For example, the metadata of the timing packet in PTP or Network Time Protocol (NTP) may include the receive timestamp as one of its elements. Further, the metadata can be configured to additionally indicate an acceptable threshold range that defines a maximum time difference allowed between an ingress network device (such as the PE device 116) and an egress network device. The metadata may be further configured to include various indicators to identify the metadata type. For example, the metadata can include a field that indicates the type of message or packet, such as PTP message types may include Sync, Follow_Up, Delay_Req, or Delay_Resp.

In yet more embodiments, the PE device 116 may encapsulate the timing packet and propagate the encapsulated timing packet through the core network 106. The timing packet may be encapsulated to include additional headers or protocol headers to ensure proper handling across the core network 106. The core network 106 may utilize various transport services such as Multiprotocol Label Switching (MPLS), Segment Routing over IPv6 (SRv6), Generic Routing Encapsulation (GRE) tunnel, etc. as packet transport mechanism. Thus, requiring the timing packet to be encapsulated as per the specific transport protocol being utilized by the core network 106. In many further embodiments, the PE device 116 may capture the receive timestamp in the timing packet prior to encapsulating the timing packet. In still yet more embodiments, to propagate the encapsulated timing packet through the core network 106, the PE device 116 may forward the encapsulated timing packet via a transmit port coupled to the core network 106. The transmit port (similar to the receive port RX) may also refer to a physical or logical interface through which data packets may exit the PE device 116.

In many additional embodiments, the timing packet may be propagated through the core network 106. The core network 106 may include various intermediate nodes 120A, 120B that may be configured to forward timing packets without any timestamp processing. The core network 106 may further include a clock source 118 that may be utilized to synchronize the timings for the intermediate nodes 120A, 120B or other network nodes functioning within the core network 106.

In still yet further embodiments, the network environment 100 may further include another PE device 122. The PE device 122 may refer to an egress network device that serves as an exit point for the traffic leaving the core network 106 and entering the access network A2 104. In other words, the PE device 122 may be located at a boundary between the core network 106 and the access network A2 104. Further, the PE device 122 may include one or more receive ports, of which at least one receive port is communicatively coupled to the core network 106, and one or more transmit ports, of which at least one transmit port (labeled as “TX” in FIG. 1) is communicatively coupled to the access network A2 104.

In still yet additional embodiments, the PE device 122 may receive the encapsulated timing packet from the intermediate node 120B. The PE device 122 may decapsulate the timing packet. The decapsulation of the timing packet may include removal of any additional headers that were added to the timing packet during encapsulation at the PE device 116.

In still yet additional embodiments, the PE device 122 may update the correction field of the timing packet based on an existing value of the correction field and a transmit timestamp of the timing packet from the PE device 122. In an embodiment where the PE device 116 modified the correction field with the difference of the receive timestamp and the original value of the correction field, the PE device 122 may update the correction field with a value obtained by subtracting the existing value of the correction field from the transmit timestamp of the PE device 122. Continuing the above example, if the existing value of the correction field indicates the difference of the receive timestamp 12:56:00 and the original value of the correction field “8 ns”, the PE device 122 may subtract from a transmit timestamp “12:56:45”, the existing value of the correction field and update the correction field with a resultant value, e.g., (12:56:45−12:56:00+8 ns). In other embodiments, the receive timestamp may be captured in the metadata. In such embodiments, the PE device 122 may update the correction field further based on the receive timestamp of the timing packet captured in the metadata. For example, the PE device 122 may update the correction field by adding to the existing value of the correction field, a difference between the receive timestamp of the PE device 116 obtained from the metadata and the transmit timestamp of the PE device 122. By updating the correction field, the PE device 122 may capture a total delay experienced by the timing packet in the correction field.

In several more embodiments, the PE device 122 may forward, at the transmit timestamp, the timing packet with the updated correction field to an access node 124 in the access network A2 104. Continuing with the above example, the PE device 122 may transmit the timing packet with the updated correction field at the transmit timestamp of “12:56:45”. In yet more embodiments, the PE device 122 may transmit the timing packet via the transmit port TX coupled to the access network A2 104, for example, the transmit port TX coupled to the access node 124.

In yet various embodiments, the access node 124 may utilize the timing value and the correction field present in the timing packet to synchronize its clock with the master clock of the access network A1 102. The PE devices 116 and 122 may, therefore, act as a transparent clock for propagating the timing packet from the access network A1 102 to the access network A2 104. Thus, making the propagation of the timing packet from the access network A1 102 via the core network 106 transparent to the access network A2 104.

In numerous embodiments, prior to forwarding the timing packet to the access node 124, the PE device 122 may determine the time difference between the transmit timestamp of the PE device 122 and the receive timestamp of the PE device 116, for the timing packet. If the determined time difference is within the acceptable threshold range, as indicated by the metadata, the PE device 122 may permit forwarding of the timing packet to the access node 124. However, if the time difference exceeds the acceptable threshold range, the PE device 122 may discard the timing packet to prevent incorrect clock synchronization data from propagating to the access network A2 104.

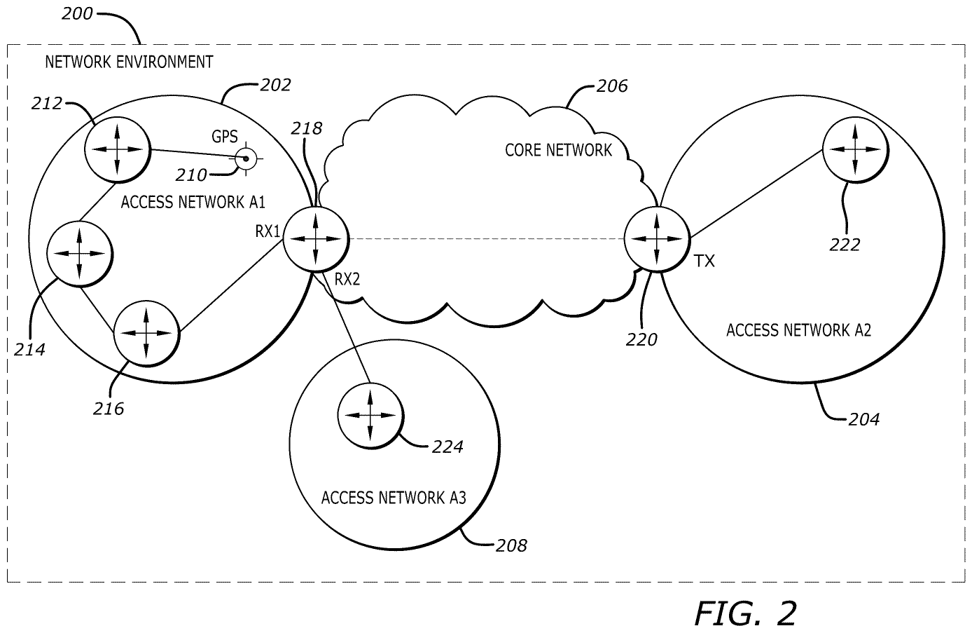

Although a specific embodiment showing a network environment for clock synchronization across a plurality of access networks connected through a core network suitable for carrying out the various steps, processes, methods, and operations described herein is discussed with respect to FIG. 1, any of a variety of systems and/or processes may be utilized in accordance with embodiments of the disclosure. In numerous embodiments, the PE device 122 may be capable of blocking the timing packets received from the core network 106. The elements depicted in FIG. 1 may also be interchangeable with other elements of FIGS. 2-13 as required to realize a particularly desired embodiment.

Referring to FIG. 2, a conceptual illustration depicting a network environment 200 for clock synchronization across a plurality of access networks using a relay state port property in accordance with various embodiments of the disclosure is shown. As depicted by FIG. 2, in many embodiments, an access network A1 202 and an access network A2 204 may be connected to each other through a core network 206. In some examples, the access network A1 202 and the access network A2 204 may belong to the same network domain. In some other examples, the access network A1 202 and the access network A2 204 may belong to different network domains.

In a variety of embodiments, the access network A1 202 may include a clock source 210 and various access nodes 212, 214, and 216. The clock source 210, for example, a GPS clock source, may provide clock signals that can be utilized to synchronize network equipment operating in the network environment 200. In an example scenario, the clock source 210 may be utilized by the access node 212 for synchronizing clocks of other access nodes in the access network A1 202 and/or the access network A2 204. In additional embodiments, the access nodes 212, 214, 216 can operate as boundary clocks or transparent clocks.

In still further embodiments, the network environment 200 may include PE devices 218, 220. The PE device 218, located at a boundary between the access network A1 202 and the core network 206, may act as an ingress network device for traffic flowing from the access network A1 202 towards the core network 206. In other words, the PE device 218 may serve as an entry point for traffic entering into the core network 206 from the access network A1 202. In several embodiments, the PE device 218 may include one or more receive ports (labeled as RX1, RX2 in FIG. 2) and a transmit port. The receive ports RX1, RX2 may refer to physical or logical interfaces through which network traffic packets may enter the PE device 218, whereas the transmit port may refer to physical or logical interfaces through which network traffic packets may exit the PE device 218 and enter the core network 206. As shown in FIG. 2, the receive port RX1 may be coupled to the access node 216, while the receive port RX2 may be coupled to another access node 224 in another access network A3 208.

Further, the PE device 220, located at a boundary between the core network 206 and the access network A2 204, may act as an egress network device for traffic flowing from the core network 206 towards the access network A2 204. In other words, the PE device 220 may serve as an exit point for traffic exiting the core network 206 and entering the access network A2 204. In several embodiments, the PE device 220 may include one or more receive ports and a transmit port (labeled as TX in FIG. 2). The receive ports may refer to physical or logical interfaces through which network traffic packets may enter the PE device 220, whereas the transmit port TX may refer to physical or logical interfaces through which network traffic packets may exit the PE device 220 and enter the access network A2 204. As shown in FIG. 2, the receive ports may be coupled to the core network 206, while the transmit port TX may be coupled to an access node 222 in the access network A2 204.

In still additional embodiments, the PE device 218 may receive a first timing packet from the access node 216 at the receive port RX1. The first timing packet may include a timing value and a correction field. A correction field value may be representative of cumulative delay the first timing packet has encountered after it was transmitted by a source device (for example, the access node 212). In yet more embodiments, the PE device 218 may further receive a second timing packet from the access node 224 at the receive port RX2.

In still yet more embodiments, the receive ports RX1, RX2 of the PE device 218 may be associated with a relay state port property. The relay state property may indicate a specific operational mode for the PE device 218 based on whether the relay state property is enabled or disabled. For example, if the relay state property is enabled for a receive port, timing packets received at such receive port can be forwarded, whereas if the relay state property is disabled for a receive port, timing packets received at such receive port are to be dropped.

Thus, based on receiving the first timing packet and the second timing packet, the PE device 218 may be configured to determine whether the relay state property associated with the receive ports RX1 and RX2 is enabled or not. Considering an example scenario, in many further embodiments, the relay state port property for the receive port RX1 may be enabled, while the relay state port property for the receive port RX2 may be disabled. Thus, the PE device 218 can forward the first timing packet received at the receive port RX1 but has to drop the second timing packet received at the receive port RX2.

Prior to forwarding the first timing packet, in yet more embodiments, the PE device 218 may capture, in the first timing packet, a receive timestamp of receiving the first timing packet at the receive port RX1. In an example, the PE device 218 may capture the receive timestamp in the correction field by modifying an existing value of the correction field with a value indicating a difference of the receive timestamp and the existing value of the correction field. In another example, the PE device 218 may capture the receive timestamp in the first timing packet by embedding metadata indicating the receive timestamp in the first timing packet. In one or more embodiments, the PE device 218 may add an encapsulation to the first timing packet prior to forwarding the first timing packet.

In many additional embodiments, the encapsulated first timing packet may propagate through the core network 206 and reach the PE device 220. Thus, the PE device 220 may receive the encapsulated first timing packet. In still yet additional embodiments, the PE device 220 may decapsulate the first timing packet and update the correction field of the first timing packet. The PE device 220 may update the correction field based on an existing value of the correction field and a transmit timestamp of the first timing packet from the PE device 220. In an embodiment where the PE device 218 modified the correction field with the difference of the receive timestamp and the original value of the correction field, the PE device 220 may update the correction field with a value obtained by subtracting the existing value of the correction field from the transmit timestamp of the PE device 220. In other embodiments, where the receive timestamp is captured in the metadata, the PE device 220 may update the correction field further based on the receive timestamp of the first timing packet captured in the metadata. For example, the PE device 220 may update the correction field by adding to the existing value of the correction field, a difference between the receive timestamp of the PE device 218 obtained from the metadata and the transmit timestamp of the PE device 220. Further, the PE device 220 may forward, at the transmit timestamp, the first timing packet with the updated correction field to the access node 222 in the access network A2 204 via the transmit port TX.

Although a specific embodiment showing a network environment for clock synchronization across a plurality of access networks using a relay state port property suitable for carrying out the various steps, processes, methods, and operations described herein is discussed with respect to FIG. 2, any of a variety of systems and/or processes may be utilized in accordance with embodiments of the disclosure. In several more embodiments, at a receive port, the relay state port property may be enabled for specific type of timing packets, such as PTP message types Sync, Follow_Up, Delay_Req, Delay_Resp, etc. In such embodiments, only the specific type of timing packets received at the receive port can be forwarded and any other type of timing packets even if received at the receive port with the relay state port property enabled are dropped. The elements depicted in FIG. 2 may also be interchangeable with other elements of FIGS. 1 and 3-13 as required to realize a particularly desired embodiment.

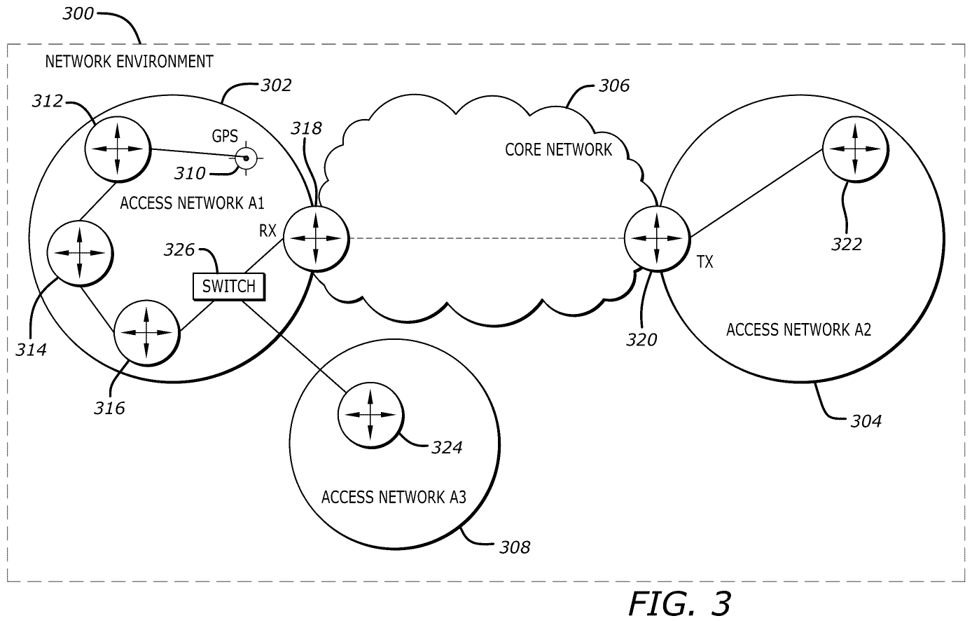

Referring to FIG. 3, a conceptual illustration depicting a network environment 300 for clock synchronization across a plurality of access networks using a relay identifier in accordance with various embodiments of the disclosure is shown. As depicted by FIG. 3, in many embodiments, an access network A1 302 and an access network A2 304 may be connected to each other through a core network 306. In some examples, the access network A1 302 and the access network A2 304 may belong to the same network domain. In some other examples, the access network A1 302 and the access network A2 304 may belong to different network domains. In a variety of embodiments, the network environment 300 may include another access network A3 308 that may also be coupled to the core network 306. The access network A3 308 may or may not belong to the same timing domain as the access network A1 302 and the access network A2 304.

In a variety of embodiments, the access network A1 302 may include a clock source 310 and various access nodes 312, 314, 316. The clock source 310, for example, a GPS clock source, may provide clock signals that can be used to synchronize network equipment operating in the network environment 300. In more embodiments, the clock source 310 may be utilized by the access node 312 for synchronizing clocks of other access nodes in the access network A1 302 and/or the access networks A2 304. In additional embodiments, the access nodes 312, 314, 316 can operate as boundary clocks or transparent clocks.

In still further embodiments, the network environment 300 may include PE devices 318, 320. The PE device 318, located at a boundary between the access network A1 302 and the core network 306, may act as an ingress network device for traffic flowing from the access network A1 302 towards the core network 306. In several embodiments, the PE device 318 may include one or more receive ports (labeled as RX in FIG. 3) and a transmit port. The receive port RX may refer to physical or logical interfaces through which network traffic packets may enter the PE device 318, whereas the transmit port may refer to physical or logical interfaces through which network traffic packets may exit the PE device 318 and enter the core network 306. As shown in FIG. 3, the receive port RX may be coupled to a switch 326, which in turn is coupled to the access node 316 and another access node 324 in the access network A3 308. In other words, the same receive port RX of the PE device 318 can be coupled to more than one access nodes in the same network domain or different network domains, in the same access network or different access networks, via a switch.

Further, the PE device 320, located at a boundary between the core network 306 and the access network A2 304, may act as an egress network device for traffic flowing from the core network 306 towards the access network A2 304. In other words, the PE device 320 may serve as an exit point for traffic exiting the core network 306 and entering the access network A2 304. In several embodiments, the PE device 320 may include one or more receive ports and a transmit port (labeled as TX in FIG. 3). The receive ports may refer to physical or logical interfaces through which network traffic packets may enter the PE device 320, whereas the transmit port TX may refer to physical or logical interfaces through which network traffic packets may exit the PE device 320 and enter the access network A2 304. As shown in FIG. 3, the receive ports may be coupled to the core network 306, while the transmit port TX may be coupled to an access node 322 in the access network A2 304.

In still additional embodiments, considering an example scenario, the PE device 318 may receive a first timing packet and a second timing packet at the receive port RX. The first timing packet may be received from the access node 316 via the switch 326, while the second timing packet may be received from the access node 324 via the switch 326. Both the first and second timing packets may include corresponding timing values, correction fields, and relay identifiers. A relay identifier may be configured to indicate at least one of a source entity associated with a timing packet or a source port that provided the timing packet to the receive port RX or the access network timing domain itself. Further, the relay identifier of a timing packet may be utilized to track the identity of intermediate network devices (such as switches, routers, APs, etc.) that may have processed or forwarded the timing packet within the network environment 300. In the illustrated example scenario, a first relay identifier in the first timing packet may indicate that the access node 312 is the source entity of the first timing packet, while a second relay identifier in the second timing packet may indicate that the access node 324 is the source entity of the second timing packet.

In several embodiments, a relay identifier may be utilized to indicate a specific port of a network device as a source entity associated with a timing packet. In an example scenario, a plurality of ports of the same network device, such as the access node 316, may be coupled to the receive port RX of the PE device 318 via the switch 326. In further examples, a plurality of ports of the same network device, such as the access node 316, may be coupled to the receive port RX of the PE device 318 without the switch 326. The PE device 318 may receive a first timing packet from a first port of the access node 316 and a second timing packet from a second port of the access node 316. Both the first and the second timing packets may include corresponding timing values, correction fields, and relay identifiers. The relay identifiers of the timing packets may, thus, be utilized to track the specific ports of the access node 316 (or any other source entity) that may have processed or forwarded the timing packet within the network environment 300. For example, a first port may be associated with an ethernet port while a second port may be associated with a Network Interface Card (NIC) port. Thus, based on the relay identifiers of the timing packets, the PE device 318 may determine the type of port, a class of the timing packets, or the.

In still yet more embodiments, upon receiving a timing packet at the receive port RX, the PE device 318 may determine whether a relay identifier is included in the timing packet. If the relay identifier is included, the PE device 318 may further determine whether the relay identifier has a preset value. For example, the relay identifier may refer to a unique network address, device ID, or other such information that helps in identifying devices in the network. By determining whether the relay identifier has the preset value, the PE device 318 determines whether the received timing packet is provided by an allowed source entity or not. For example, the PE device 318 may have a first list of relay identifiers for which forwarding of timing packets may be allowed, and a second list of relay identifiers for which forwarding of timing packet may be blocked. Based on the determination that the relay identifier has the preset value from the first list of relay identifiers, the PE device 318 may forward the timing packet, whereas based on the determination that the relay identifier has the preset value from the second list of relay identifiers, the PE device 318 may drop the timing packet.

Continuing the above example scenario, the PE device 318 may determine whether the first relay identifier in the first timing packet and the second relay identifier in the second timing packet have preset values from the first list of relay identifiers. In an example, the PE device 318 may determine that the first relay identifier has the preset value from the first list of relay identifiers, whereas the second relay identifier does not have any preset value from the first list of relay identifiers. In other words, based on the first relay identifier, the PE device 318 may determine that the access node 314 is an allowed source entity for providing timing packets, and the access node 324 is not an allowed source entity for providing timing packets. Thus, the PE device 318 may permit forwarding of the first timing packet, while dropping the second timing packet.

Prior to forwarding the first timing packet, in yet more embodiments, the PE device 318 may capture, in the first timing packet, a receive timestamp of receiving the first timing packet at the receive port RX. In an example, the PE device 318 may capture the receive timestamp in the correction field by modifying an existing value of the correction field with a value indicating a difference of the receive timestamp and the existing value of the correction field. In another example, the PE device 318 may capture the receive timestamp in the first timing packet by embedding metadata indicating the receive timestamp in the first timing packet. In one or more embodiments, the PE device 318 may add an encapsulation to the first timing packet prior to forwarding the first timing packet to the core network 306.

In many additional embodiments, the encapsulated first timing packet may propagate through the core network 306 and reach the PE device 320. Thus, the PE device 320 may receive the encapsulated first timing packet. In still yet additional embodiments, the PE device 320 may decapsulate the first timing packet and update the correction field of the first timing packet. The PE device 320 may update the correction field based on an existing value of the correction field and a transmit timestamp of the first timing packet from the PE device 320. In an embodiment where the PE device 318 modified the correction field with the difference of the receive timestamp and the original value of the correction field, the PE device 320 may update the correction field with a value obtained by subtracting the existing value of the correction field from the transmit timestamp of the PE device 320. In other embodiments, where the receive timestamp is captured in the metadata, the PE device 320 may update the correction field further based on the receive timestamp of the first timing packet captured in the metadata. For example, the PE device 320 may update the correction field by adding to the existing value of the correction field, a difference between the receive timestamp of the PE device 318 obtained from the metadata and the transmit timestamp of the PE device 320. Further, the PE device 320 may forward, at the transmit timestamp, the first timing packet with the updated correction field to the access node 322 in the access network A2 304 via the transmit port TX.

Although a specific embodiment showing a network environment for clock synchronization across a plurality of access networks using a relay identifier suitable for carrying out the various steps, processes, methods, and operations described herein is discussed with respect to FIG. 3, any of a variety of systems and/or processes may be utilized in accordance with embodiments of the disclosure. In several more embodiments, along with checking for relay identifier in the timing packet, the PE device 318 can also check whether a relay state property of the receive port RX is enabled or not, prior to forwarding any timing packet. The elements depicted in FIG. 3 may also be interchangeable with other elements of FIGS. 1-2 and 4-13 as required to realize a particularly desired embodiment.

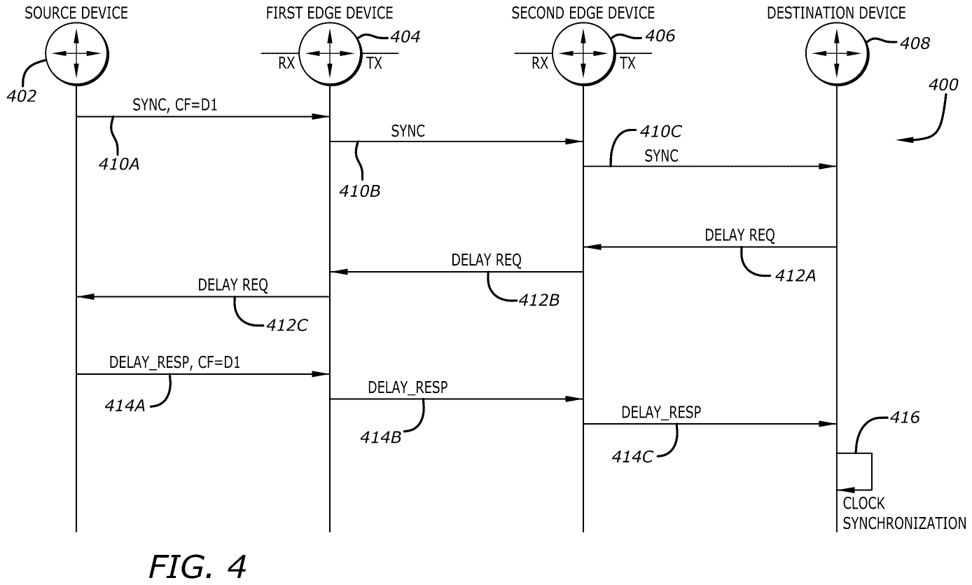

Referring to FIG. 4, a conceptual diagram 400 illustrating message flow between a source device and a destination device via a core network in accordance with various embodiments of the disclosure is shown. In many embodiments, the scenario as depicted in FIG. 4 may show a clock synchronization process between a source device 402 and a destination device 408. In a number of embodiments, the source device 402 and the destination device 408 may be configured to conform to a precision time synchronization protocol (e.g., PTP as defined in the IEEE 1588 protocol) to precisely coordinate time with each other. Further, the source device 402 and the destination device 408 may be communicatively coupled via a first edge device 404 and a second edge device 406.

In many embodiments, the source device 402 may transmit a first timing packet (for example, a Sync packet as shown in FIG. 4) having a correction field (CF) value as D1 to the first edge device 404. Transmission of the first timing packet from the source device 402 to the first edge device 404 is shown by way of an arrow 410A in FIG. 4. In a variety of embodiments, the first timing packet (the Sync packet) may be received by the first edge device 404 at a receive port. The first edge device 404 may function as an ingress network device. The first edge device 404 may capture, in the first timing packet, a receive timestamp of receiving the first timing packet at the receive port. The first timing packet may include a first timing value and a correction field having the CF value “D1”. For example, the first timing value may represent a precise timestamp (e.g., “T1”) at which the first timing packet was transmitted by the source device 402. The correction field in the first timing packet may be used to account for various delays, such as processing delay, transmission time, queuing delay, or the like, encountered by the first timing packet as the first timing packet travels through the network. In several embodiments, to capture the receive timestamp in the first timing packet, the first edge device 404 may modify the CF value “D1” based on the receive timestamp. For example, the updated CF value may be a resultant value obtained by subtracting “D1” from the receive timestamp.

In more embodiments, the first edge device 404 may forward the first timing packet (Sync packet) with the updated CF value to the second edge device 406. Transmission of the first timing packet from the first edge device 404 to the second edge device 406 is shown by way of an arrow 410B in FIG. 4. In numerous embodiments, traversal of the first timing packet from the first edge device 404 to the second edge device 406 may be through a core network. The second edge device 406 may function as an egress network device. The second edge device 406 may process the first timing packet and further update the correction field. For example, the second edge device 406 may update the correction field based on an existing value of the correction field and a transmit timestamp of the first timing packet from the second edge device 406. For example, the transmit timestamp may indicate the precise time at which the first timing packet may be transmitted from the second edge device 406. Thus, the second edge device 406 may update the correction field with a resultant value obtained by subtracting the existing value of the correction field in the first timing packet received at the second edge device 406 from the transmit timestamp of the second edge device 406.

In additional embodiments, the first timing packet may then be forwarded by the second edge device 406 to the destination device 408. Transmission of the first timing packet from the second edge device 406 to the destination device 408 is shown by way of an arrow 410C in FIG. 4. Thus, in this manner, the correction field captures the delay between the first timing packet being received at the first edge device 404 and transmitted by the second edge device 406.

In further embodiments, upon receiving the first timing packet, the destination device 408 may extract the first timing value and the updated correction field value from the first timing packet. Further, the destination device 408 may record a timestamp “T2” of receiving the first timing packet. The destination device 408 may then transmit a second timing message (e.g., a Delay_Req message) at timestamp “T3” to the second edge device 406. Delay_Req message may be sent by a slave clock (for example the destination device 408) to a master clock (for example the source device 402) to measure a network delay between the two devices. The second edge device 406 may now operate as an ingress network device, and may modify a correction field of the second timing message to capture a receive timestamp of receiving the second timing message. The second edge device 406 may forward the second timing message with updated correction field to the first edge device 404, which may now operate as the egress network device. The first edge device 404 may modify the correction field based on an existing value of the correction field and a transmit timestamp of the second timing message. The second timing message may then be forwarded by the first edge device 404 to the source edge device 402. Transmission of the second timing message from the destination device 408 to the second edge device 406, then to the first edge device 404, and finally to the source device 402 is shown in FIG. 4 by way of arrows 412A, 412B, 412C, respectively.

In still more embodiments, upon receiving the second timing packet, the source device 402 may record a timestamp “T4” indication a reception time of the second timing packet at the source device 402. The source device 402 may then transmit a third timing message (e.g., a Delay_Resp message) to the first edge device 404, which may again operate as an ingress network device. The Delay_Resp message may provide the slave device (for example, the destination device 408) with the timing value about when the master device (for example, the source device 402) received the Delay_Req message from the slave device. Thus, the third timing message may include a timing value “T4” and a correction field (e.g., CF=D1).

The first edge device 404, upon receiving the third timing message, may modify the correction field to indicate a difference of a receive timestamp for the third timing message and an existing value of the correction field. In still further embodiments, the first edge device 404 may forward the third timing message to the second edge device 406, which after further modifying the correction field may forward the third timing message to the destination device 408. Transmission of the third timing message from the source device 402 to the first edge device 404, then to the second edge device 406, and finally to the destination device 408 is shown in FIG. 4 by way of arrows 414A, 414B, 414C, respectively.

In still additional embodiments, the destination device 408 may perform clock synchronization (as indicated by an arrow 416) with the source device 402 based on various timing values “T1”, T2”, “T3”, “T4” and various correction field values obtained from the first timing message and the second timing message.

Thus, when a timing packet traverses through an ingress network, an existing value of the correction field may be modified to indicate a difference of the receive timestamp and the existing value of the correction field. This way the modified correction field accounts for the receive timestamp at the core network. Similarly, when the timing packet is received by an egress network device, the correction field may be updated again based on the updated value of the correction field and a transmit timestamp egress network device to indicate a timing delay associated with the core network.

Although a specific embodiment showing a network environment for clock synchronization across a plurality of access networks connected through a core network suitable for carrying out the various steps, processes, methods, and operations described herein is discussed with respect to FIG. 4, any of a variety of systems and/or processes may be utilized in accordance with embodiments of the disclosure. In numerous embodiments, the second edge device 406 may block the timing packets received from the core network for time synchronization of the destination device 408. The elements depicted in FIG. 4 may also be interchangeable with other elements of FIGS. 1-3 and 5-13 as required to realize a particularly desired embodiment.

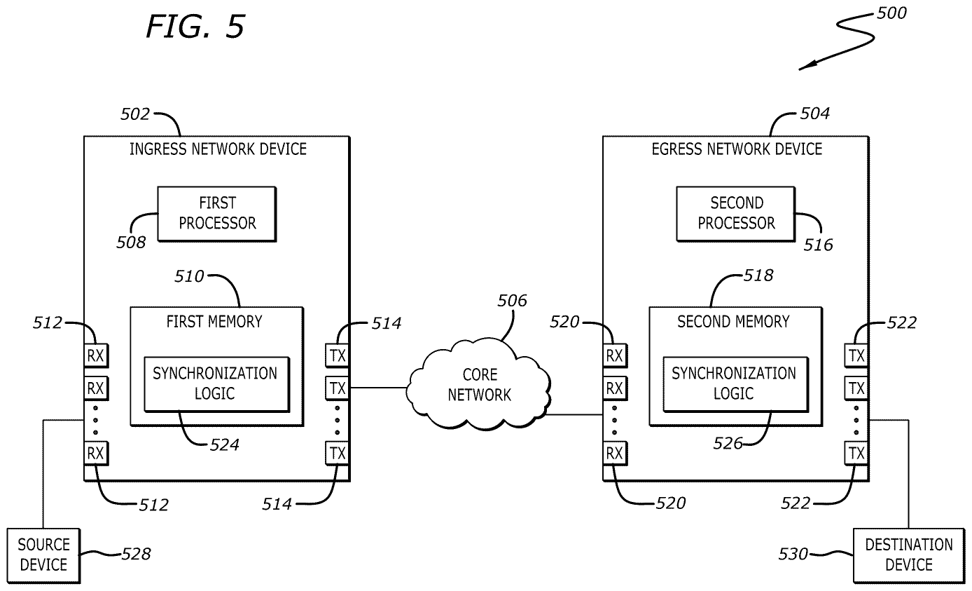

Referring to FIG. 5, a conceptual diagram 500 illustrating an ingress network device and an egress network device that implements a clock synchronization process in accordance with various embodiments of the disclosure is shown. The embodiments depicted in the conceptual diagram 500 may show a scenario of stateless clock propagation between an ingress network device 502 and an egress network device 504 connected through a core network 506. In an example scenario, the ingress network device 502 and the egress network device 504 may be provider edge devices. In a number of embodiments, the ingress network device 502 may include a first processor 508, a first memory 510, one or more receive ports 512, and one or more transmit ports 514. Likewise, the egress network device 504 may include a second processor 516, a second memory 518, one or more receive ports 520, and one or more transmit ports 522.

In various embodiments, the first and second processors 508, 516 may be implemented as one or more microprocessors, microcomputers, microcontrollers, digital signal processors, central processing units, logic circuitries, and/or any devices that process data based on operational instructions. Among other capabilities, the first and second processors 508, 516 may be configured to fetch and execute computer-readable instructions stored in the first and second memories 510, 518, respectively. Further examples of the first and second processors 508, 516 may include Application-Specific Integrated Circuit (ASIC) processors, Reduced Instruction Set Computing (RISC) processors, Complex Instruction Set Computing (CISC) processors, Field-Programmable Gate Arrays (FPGAs), Digital Signal Processor (DSPs), or the like.

In yet various embodiments, the first and second memories 510, 518 may be coupled to the first and second processors 508, 516, respectively. The first and second memories 510, 518 may be configured to store one or more computer-readable instructions or routines in a non-transitory computer-readable storage medium, which may be fetched and executed by respective first and second processors 508, 516. The first and second memories 510, 518 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the first and second memories 510, 518 in the ingress network device 502 and the egress network device 504, respectively, as described herein. In several embodiments, the first and second memories 510, 518 may be realized in the form of a database server or a cloud storage working in conjunction with the ingress network device 502 and the egress network device 504, respectively, without departing from the scope of the disclosure.

In more embodiments, the first and second memories 510, 518 may store synchronization logics 524, 526, respectively. The synchronization logics 524, 526 may include instructions, such as a set of codes, to enable transparent clock propagation from a source device 528 to a destination device 530 through the core network 506.

In further embodiments, the ingress network device 502 may be connected to the source device 528 via the receive port 512. For example, the source device 528 may function as a clock source. The clock source may be a GPS clock source. In various embodiments, the source device 528 may generate a timing packet that may be received by the ingress network device 502 at the receive ports 512 coupled to the source device 528. In additional embodiments, upon receiving the timing packet at the receive port 512, the synchronization logic 524 may capture, in the timing packet, a receive timestamp of receiving the timing packet as described in the foregoing description of FIGS. 1, 2, 3, and 4.

In still more embodiments, the ingress network device 502 may forward the timing packet after encapsulation via one of the transmit ports 514 and the core network 506 to the egress network device 504. Since the timing packet is encapsulated, network nodes in the core network 506 are unable modify any packet element within the encapsulation. Thus, the receive timestamp captured in the timing packet is propagated to the egress network device 504. The egress network device 504 may receive the timing packet via a receive port of the one or more receive ports 520. The synchronization logic 526 may thus process the received timing packet to update a correction field. For example, the synchronization logic 526 may update the correction field based on an existing value of the correction field and a transmit timestamp of the timing packet from the egress network device 504. In further embodiments, if the received timestamp is captured in a metadata embedded in the timing packet, the synchronization logic 526 may further utilize the receive timestamp to update the correction field.

The egress network device 504, in still further embodiments, may forward the timing packet with the updated correction field via a transmit port of the one or more transmit ports 522 to the destination device 530. The destination device 530 may utilize the timing packet with the updated correction field to synchronize its clock with the source device 528. Thus, the core network 506 along with the ingress network device 502 and the egress network device 504 may be perceived as a single entity functioning as a transparent clock.

Although a specific embodiment showing a clock synchronization process between a source device and a destination device suitable for carrying out the various steps, processes, methods, and operations described herein is discussed with respect to FIG. 5, any of a variety of systems and/or processes may be utilized in accordance with embodiments of the disclosure. In numerous embodiments, the ingress network device 502 and the egress network device 504 may negotiate one or more PTP attributes to create a permit or deny list for processing of the timing packet. The one or more PTP attributes may refer to PTP message type (such as Sync, Follow_Up, Delay_Req, or the like), clock type (such as Grandmaster clock, boundary clock, or the like), or any such attributes as defined in the IEEE 1588 standard. The elements depicted in FIG. 5 may also be interchangeable with other elements of FIGS. 1-4 and 6-13 as required to realize a particularly desired embodiment.

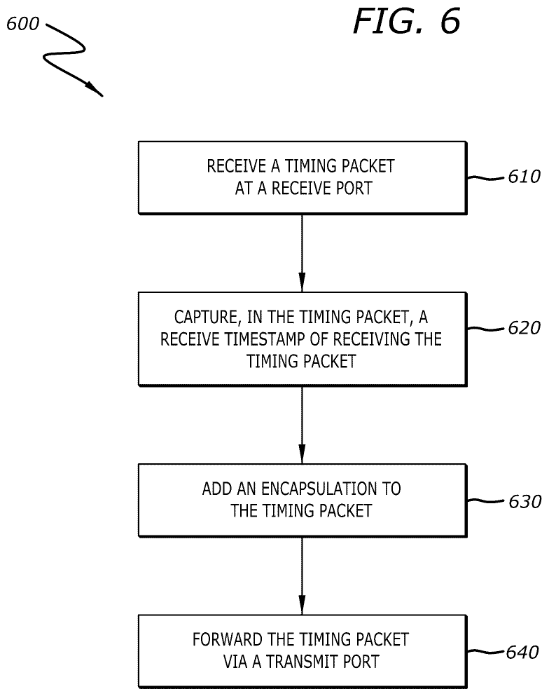

Referring to FIG. 6, a flowchart showing a process 600 for forwarding a timing packet by an ingress network device in accordance with various embodiments of the disclosure is shown. In many embodiments, the process 600 may receive a timing packet at a receive port (block 610). The process 600 may receive the timing packet at the receive port of an ingress network device. The ingress network device may refer to a network device that handles incoming network traffic at the boundary or entry point of a network or subnet. In an example scenario, the ingress network device may operate at the boundary between an access network and a core network. Examples of the ingress network device may include routers, firewalls, switches, gateways, APs, or any other suitable edge device. The ingress network device may have multiple ports used for supporting the flow of data into the network. In a number of embodiments, the process 600 may receive the timing packet such as a PTP packet, a NTP packet, Time Sync Messages, or other timing protocol packets. The timing packet may include a timing value and a correction field, in addition to other information as per the timing protocol.

In a variety of embodiments, the process 600 may capture, in the timing packet, a receive timestamp of receiving the timing packet (block 620). The process 600 may capture the receive timestamp of receiving the timing packet by modifying an existing value of the correction field based on the receive timestamp. The correction field of the timing packet may be configured to store accumulated time offsets or delays that occur as the timing packet travels through various network devices in a network. In more embodiments, the process 600 may modify the existing value of the correction field to indicate a difference of the receive timestamp and the existing value of the correction field. The process 600 may thus replace the existing value of the correction field with the difference of the receive timestamp and the existing value of the correction field. Considering an example scenario, if an existing value of the correction field is “8 ns” and the ingress network device receives the timing packet at “12:56:00”, the process 600 may replace the existing value of the correction field with a value obtained by subtracting “8 ns” from the receive timestamp “12:56:00” of the timing packet.

In further embodiments, the process 600 may add an encapsulation to the timing packet (block 630). Encapsulation may refer to wrapping the timing packet in an additional header or protocol layer to ensure proper handling across the core network. The core network may utilize various transport services (such as MPLS, SRv6, GRE tunnel, etc.) and thus, requires the timing packet to be encapsulated as per the specific transport protocol being used.

In additional embodiments, the process 600 may forward the timing packet via a transmit port (block 640). The transmit port (as well as the receive port) may refer to a physical or logical interface through which data packets may enter or exit a network device. Examples of the transmit and the receive ports can include ethernet ports, fiber optic interfaces, Network Interface Cards (NICs), or the like. In bidirectional communication, an interface port can handle both incoming (receive) and outgoing (transmit) traffic. In an example scenario, the ingress network device receiving the timing packet may have one or more transmit ports for forwarding the timing packet and other traffic packets from the access network to the core network.

Although a specific embodiment showing a process for forwarding the timing packet by the ingress network device suitable for carrying out the various steps, processes, methods, and operations described herein is discussed with respect to FIG. 6, any of a variety of systems and/or processes may be utilized in accordance with embodiments of the disclosure. In yet more embodiments, instead of modifying the correction field, the process 600 may assign metadata to the timing packet for capturing the receive timestamp, where the metadata may be configured to indicate the receive timestamp. Continuing the above example, the correction field may retain the existing value of “8 ns”, and the process 600 may assign the metadata indicating the receive timestamp “12:56:00” to the timing packet. The elements depicted in FIG. 6 may also be interchangeable with other elements of FIGS. 1-5 and 7-13 as required to realize a particularly desired embodiment.

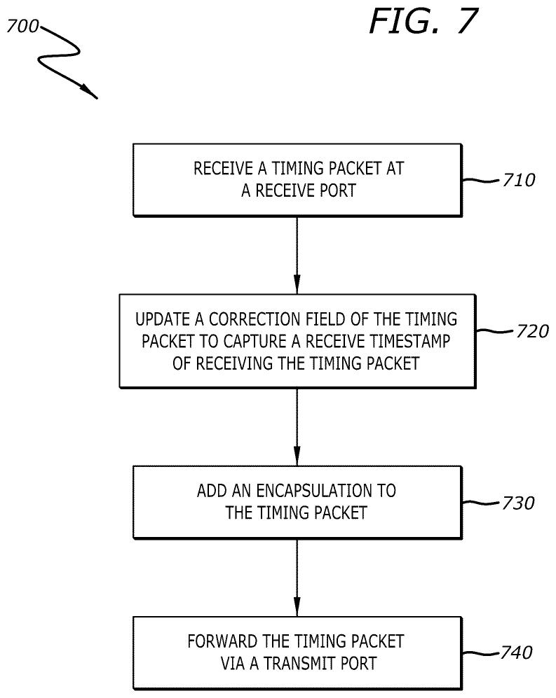

Referring to FIG. 7, a flowchart showing a process 700 for updating a correction field of a timing packet by an ingress network device in accordance with various embodiments of the disclosure is shown. In many embodiments, the process 700 may receive a timing packet at a receive port (block 710). The process 700 may receive the timing packet at the receive port of an ingress network device. The ingress network device may refer to a network device that handles incoming network traffic at the boundary or entry point of a network or subnet. In an example scenario, the ingress network device may operate at the boundary between an access network and a core network.

In a number of embodiments, the process 700 may update a correction field of the timing packet to capture a receive timestamp of receiving the timing packet (block 720). The correction field of the timing packet may be utilized to account for various delays, such as processing delay, transmission time, queuing delay, or the like, encountered by the timing packet as the timing packet travels through the network. Thus, the correction field value may be representative of cumulative delay the timing packet has encountered after it was transmitted by a source device. In various embodiments, upon receiving the timing packet, the process 700 may update the correction field value by modifying an existing value of the correction field based on the receive timestamp. For example, the process 700 may replace the existing value of the correction field with a difference of the receive timestamp and the existing value of the correction field. Thus, after update, the correction field may indicate the difference between the receive timestamp and the existing value of the correction field.

In a variety of embodiments, the process 700 may add an encapsulation to the timing packet (block 730). The process 700 may add the encapsulation to the timing packet to include an additional header or protocol layer to ensure proper handling across the core network. In more embodiments, the process 700 may encapsulate the timing packet according to the specific transport service (such as MPLS, SRv6, GRE tunnel, etc.) being utilized by the core network. In additional embodiments, the process 700 may forward the timing packet via a transmit port (block 740). The process 700 may utilize ethernet ports, fiber optic interfaces, Network Interface Cards (NICs), or any other suitable physical interface to forward the timing packet.

Although a specific embodiment showing a process for updating the correction field of a timing packet by an ingress network device suitable for carrying out the various steps, processes, methods, and operations described herein is discussed with respect to FIG. 7, any of a variety of systems and/or processes may be utilized in accordance with embodiments of the disclosure. In further embodiments, the process 700 may utilize a logical interface (such as a Virtual Local Area Network “VLAN” interface) to forward the timing packet. The elements depicted in FIG. 7 may also be interchangeable with other elements of FIGS. 1-6 and 8-13 as required to realize a particularly desired embodiment.

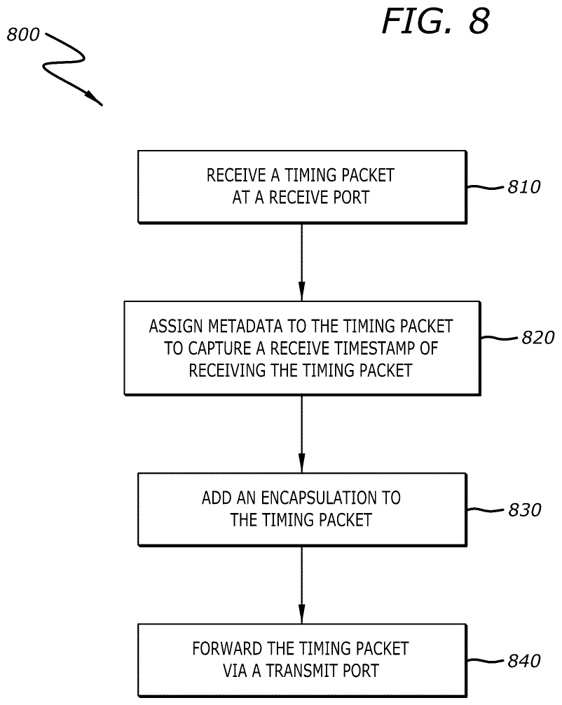

Referring to FIG. 8, a flowchart showing a process 800 for assigning metadata to a timing packet by an ingress network device in accordance with various embodiments of the disclosure is shown. In many embodiments, the process 800 may receive a timing packet at a receive port (block 810). The process 800 may receive the timing packet at the receive port of an ingress network device. In an example scenario, the ingress network device may operate at the boundary between an access network and a core network.

In a number of embodiments, the process 800 may assign metadata to the timing packet to capture a receive timestamp of receiving the timing packet (block 820). The process 800 may embed the metadata in the timing packet to indicate the receive timestamp of receiving the timing packet at the receive port of the ingress network device. In various embodiments, the metadata may be configured to additionally indicate an acceptable threshold range that defines a maximum time difference allowed between the receive timestamp at the ingress network device and a transmit timestamp at an egress network device.

In more embodiments, the process 800 may add an encapsulation to the timing packet (block 830). The process 800 may add the encapsulation to the timing packet to include an additional header or protocol layer to ensure proper handling across the core network. In additional embodiments, the process 800 may forward the timing packet via a transmit port (block 840). The process 800 may utilize ethernet ports, fiber optic interfaces, Network Interface Cards (NICs), or any other suitable physical or logical interface to forward the timing packet.

Although a specific embodiment showing a process for assigning metadata to the timing packet by an ingress network device suitable for carrying out the various steps, processes, methods, and operations described herein is discussed with respect to FIG. 8, any of a variety of systems and/or processes may be utilized in accordance with embodiments of the disclosure. In further embodiments, the process 800 may configure the metadata to include various indicators to identify the metadata type. For example, the metadata can include a field that indicates the type of message or packet, such as PTP message types may include Sync, Follow_Up, Delay_Req, or Delay_Resp. Further, the metadata can also be assigned after adding the encapsulation to the timing packet. The elements depicted in FIG. 8 may also be interchangeable with other elements of FIGS. 1-7 and 9-13 as required to realize a particularly desired embodiment.

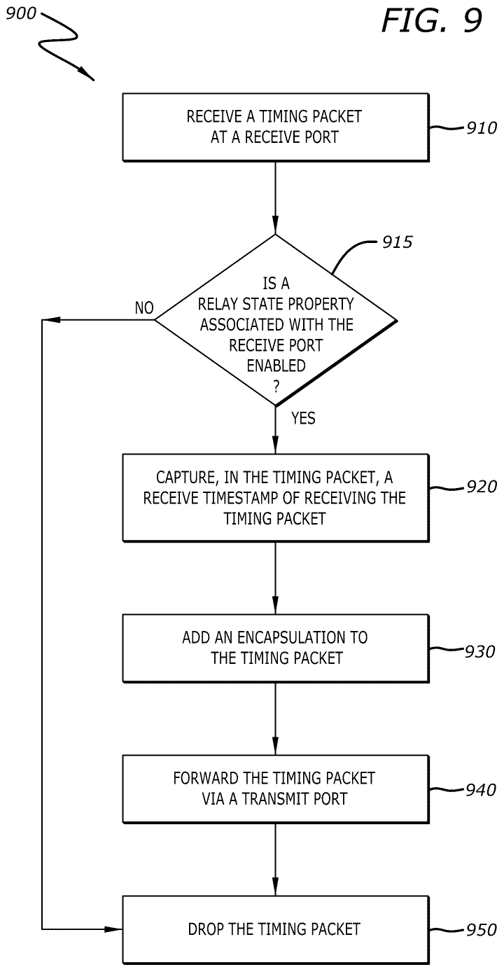

Referring to FIG. 9, a flowchart showing a process 900 for forwarding a timing packet by an ingress network device using relay state property in accordance with various embodiments of the disclosure is shown. In many embodiments, the process 900 may receive a timing packet at a receive port (block 910). The process 900 may receive the timing packet at a receive port of an ingress network device (such as edge devices including routers, firewalls, switches, gateways, APs, or the like). In a number of embodiments, the process 900 may receive the timing packet such as a PTP packet, a NTP packet, Time Sync Messages, or other timing protocol packets.

In more embodiments, the process 900 may check whether a relay state property associated with the receive port is enabled (block 915). The relay state property of a port may refer to the behavior of the port for forwarding or handling timing packets. The relay state property of a port may refer to the functionality or characteristic of a port that acts as a relay between different network segments or devices, while maintaining specific protocol states. In additional embodiments, the relay state property of the receive port may thus indicate a specific operational mode for the ingress network device, such as forwarding of the timing packets when the relay state property may be enabled, or discarding the timing packet when the relay state property of the port may be disabled. In numerous embodiments, when the relay state property of the port may not be enabled, the process 900 may perform additional timing-related functions like time correction, or participating in master-slave clock hierarchy.

If the process 900 determines that the relay state property associated with the receive port is enabled, in further embodiments, the process 900 may capture, in the timing packet, a receive timestamp of receiving the timing packet (block 920). The receive timestamp may indicate the exact timing at which the timing packet was received at the receive port of the ingress network device. The process 900 may capture the receive timestamp in a correction filed of the timing packet or in a metadata which is then embedded to the timing packet.

In still more embodiments, the process 900 may add an encapsulation to the timing packet (block 930). Encapsulation may refer to wrapping the timing packet in an additional header or protocol layer to ensure proper handling across the core network. The core network may utilize various transport services (such as MPLS, SRv6, GRE tunnel, etc.) and thus, requires the timing packet to be encapsulated as per the specific transport protocol being used.

In still further embodiments, the process 900 may forward the timing packet via a transmit port (block 940). The transmit port (as well as the receive port) may refer to a physical or logical interface through which data packets or timing packets may enter or exit a network device. In an example scenario, the ingress network device receiving the timing packet may have one or more transmit ports for forwarding the timing packet as well as other data packets from the access network to the core network.

However, if the relay state property associated with the receive port is disabled, in still more embodiments, the process 900 may drop the timing packet (block 950). The process 900 may determine that the relay state property for the receive port is disabled and thus, the receive port may not perform the functions of forwarding the timing packet. The process 900 may, therefore, drop the received timing packet.

Although a specific embodiment showing a process for forwarding a timing packet by an ingress network device using relay state property suitable for carrying out the various steps, processes, methods, and operations described herein is discussed with respect to FIG. 9, any of a variety of systems and/or processes may be utilized in accordance with embodiments of the disclosure. In several embodiments, the process 900 upon determining that the relay state property for the receive port is enabled, the process 900 may perform filtering and handling of duplicate timing packets that may occur due to network transmissions or errors. The elements depicted in FIG. 9 may also be interchangeable with other elements of FIGS. 1-6 and 8-13 as required to realize a particularly desired embodiment.

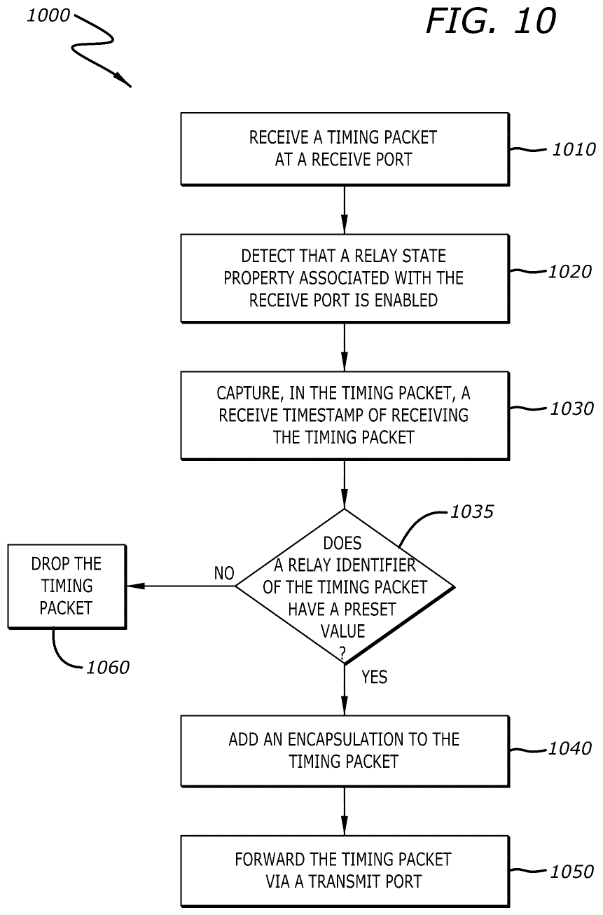

Referring to FIG. 10, a flowchart showing a process 1000 for forwarding a timing packet by an ingress network device using relay identifier in accordance with various embodiments of the disclosure is shown. In many embodiments, the process 1000 may receive a timing packet at a receive port (block 1010). In a number of embodiments, the process 1000 may receive the timing packet at a receive port of an ingress network device (such as edge devices including routers, firewalls, switches, gateways, APs, or the like).

In a variety of embodiments, the process 1000 may detect that a relay state property associated with the receive port is enabled (block 1020). In additional embodiments, the process 1000 may determine whether a specific operational mode associated with the receive port of the ingress network device is enabled or not. The process 1000 may thus permit forwarding of the received timing packet based on the determination that the relay state property associated with the port is enabled.

In more embodiments, the process 1000 may capture, in the timing packet, a receive timestamp of receiving the timing packet (block 1030). For example, when a timing packet (such as a Sync packet in PTP) is received by the ingress network device, the process 1000 may record the exact time when the timing packet arrives, and then capture the recorded receive timestamp in a correction field of the timing packet or in a metadata which is then embedded to the timing packet.

In additional embodiments, the process 1000 may determine whether a relay identifier of the timing packet has a preset value (block 1035). The relay identifier of the timing packet may be used to track an identity of network devices (such as switches, routers, APs, etc.) that may have processed or forwarded the timing packet within the network. In an example scenario, a PTP timing packet may pass through various devices along the route from the master clock to the slave clock, thus the intermediate devices can also participate in the clock synchronization process by either updating the correction field or annotating the timing packet with their own receive timestamp. The relay identifier may thus help track the route, or the path taken by the timing packet in the network. In further embodiments, the relay identifier used by the process 1000 may refer to unique network address, device ID, or other such information that helps identify the devices in the network. Thus, in other words, the relay identifier may be related to a source entity associated with the timing packet or a source port that provided the timing packet to the receive port. In still more embodiments, the process 1000 may determine whether the timing packet was provided by an allowed source entity (for example, a switch to be considered as a master clock for the network) and thus, checks that the relay identifier has a preset value. Thus, the process 1000 may take a decision whether to allow or restrict the forwarding of the timing packet, based on the relay identifier indicating the source of the timing packet.

In still further embodiments, if the relay identifier has the preset value, the process 1000 may add an encapsulation to the timing packet (block 1040). The process 1000 may encapsulate the timing packet to include additional headers in the timing packet that may allow it to be transmitted over a particular network technology, such as Ethernet, MPLS, Internet Protocol, etc. For example, if the timing packet needs to be carried through the core network, MPLS encapsulation may allow for efficient routing of the timing packet within the core network. MPLS labels may be added to the timing packet, enabling faster routing. In still yet more embodiments, the relay identifier may be carried as part of the encapsulation between the ingress network device and an egress network device.

In still additional embodiments, the process 1000 may forward the timing packet via a transmit port (block 1050). The transmit port may refer to a physical or logical interface through which data packets or timing packets may exit the ingress network device. The ingress network device may have one or more transmit ports for forwarding the timing packet as well as other data packets from the access network to the core network.

However, if the process 1000 determines that the relay identifier of the timing packet does not have a preset value, the process 1000 may drop the timing packet (block 1060). The process 1000 may determine that the timing packet is associated with a source entity not to be used for clock synchronization. Thus, the process 1000 may drop any such timing packet.

Although a specific embodiment showing a process for forwarding a timing packet by an ingress network device using relay identifier suitable for carrying out the various steps, processes, methods, and operations described herein is discussed with respect to FIG. 10, any of a variety of systems and/or processes may be utilized in accordance with embodiments of the disclosure. In several embodiments, the process 1000 may configure or negotiate the preset value of the relay identifier using any propriety or standard protocol. The elements depicted in FIG. 10 may also be interchangeable with other elements of FIGS. 1-9 and 11-13 as required to realize a particularly desired embodiment.

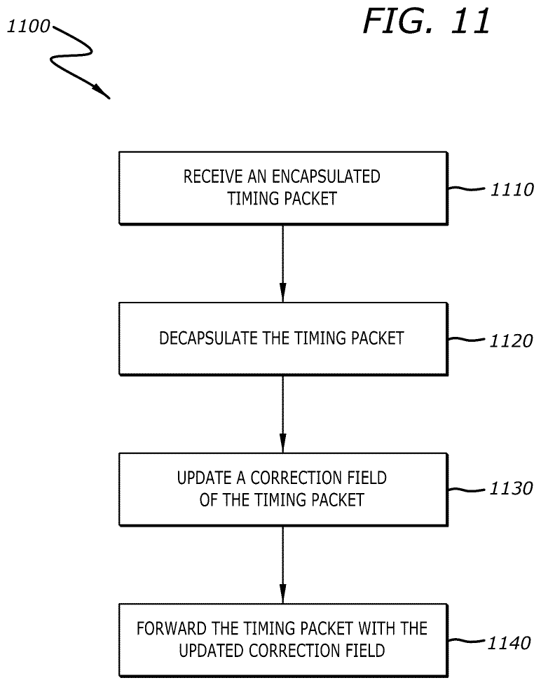

Referring to FIG. 11, a flowchart showing a process 1100 for receiving a timing packet by an egress network device in accordance with various embodiments of the disclosure is shown. In many embodiments, the process 1100 may receive an encapsulated timing packet (block 1110). The process 1100 may receive the encapsulated timing packet at a receive port of an egress network device, such as a router, a switch, an AP, or the like.

In a number of embodiments, the process 1100 may decapsulate the timing packet (block 1120). In an example scenario, the egress network device may perform the decapsulation of the timing packet. The decapsulation of the timing packet may include the removal of any additional headers that were added to the timing packet as it traversed through the core network, thus, to restore the original timing packet. For example, the process 1100 may remove any MPLS labels from PTP Sync or Delay_Req message.

In a variety of embodiments, the process 1100 may update a correction field of the timing packet (block 1130). The process 1100 may consider the egress network device as a transparent clock and may update the correction field of the timing packet to account for any delays that occurred while the timing packet traversed through the core network. In more embodiments, the process 1100 may update the correction field to account for delays such as transmission delays or queuing delays that occurred inside the core network. In still yet further embodiments, the process 1100 may update the correction field based on an existing value of the correction field and a transmit timestamp of the timing packet from the egress network device. In an example where an ingress network device modified the correction field with a difference of a receive timestamp at the ingress network device and an original value of the correction field, the process 1100 may update the correction field with a value obtained by subtracting the existing value of the correction field from the transmit timestamp of the egress network device. In further examples the receive timestamp of the ingress network device may have been captured in a metadata in the timing packet. In such embodiments, the process 1100 may first inspect the received timing packet and determine if the receiving timing packet includes any metadata that captures the receive timestamp of the ingress network device. If such metadata is identified to be present in the received timing packet, the process 1100 may update the correction field by adding to the existing value of the correction field, a difference between the receive timestamp extracted from the metadata and the transmit timestamp of the egress network device.

In further embodiments, the process 1100 may forward the timing packet with the updated correction field (block 1140). The process 1100 may forward the timing packet with the updated correction field to other devices connected to the egress network device for clock synchronization. In an example scenario, the egress network device may act as a master clock forwarding the timing packet to slave clock devices that may use the timing information to synchronize its clock with the master clock. The slave clock device may use the timestamp information from the timing packet to adjust its local time accurately.

Although a specific embodiment showing a process for receiving a timing packet by an egress network device suitable for carrying out the various steps, processes, methods, and operations described herein is discussed with respect to FIG. 11, any of a variety of systems and/or processes may be utilized in accordance with embodiments of the disclosure. In additional embodiments, the process 1100 may inspect a relay identifier in the timing packet to determine whether the timing packet can be forwarded to other devices in the network or not. For example, if the timing packet is forwarded through the transport service using Layer 3 Virtual Private Network (L3VPN) encapsulation, the process 1100 can be configured to forward the timing packet to such relay enabled nodes that belong to same Virtual Routing and Forwarding (VRF). VRFs may allow the service providers to maintain separate routing tables for different customers, where each VRF may be associated with a specific VPN. The elements depicted in FIG. 11 may also be interchangeable with other elements of FIGS. 1-10 and 12-13 as required to realize a particularly desired embodiment.

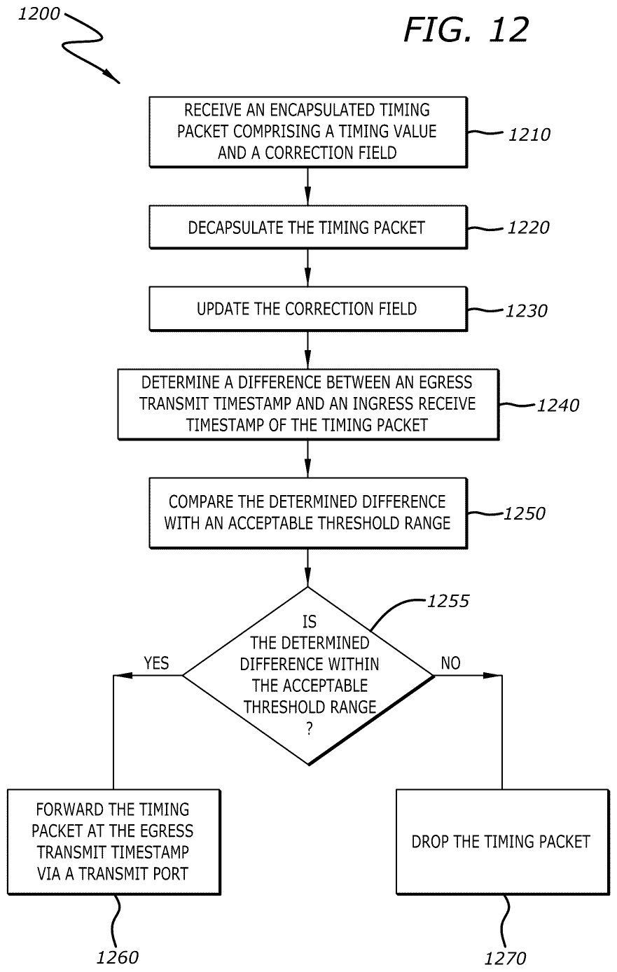

Referring to FIG. 12, a flowchart showing a process 1200 for receiving a timing packet by an egress network device in accordance with various embodiments of the disclosure is shown. In many embodiments, the process 1200 may receive an encapsulated timing packet comprising a timing value and a correction field (block 1210). The process 1200 may receive the encapsulated timing packet at a receive port of an egress network device, such as a router, a switch, an AP, or the like.

In a number of embodiments, the process 1200 may decapsulate the timing packet (block 1220). In an example scenario, the egress network device may perform the decapsulation of the timing packet. The decapsulation of the timing packet may include the removal of any additional headers that were added to the timing packet as it traversed through the core network.

In a variety of embodiments, the process 1200 may update the correction field (block 1230). In more embodiments, the process 1200 may update the correction field to account for delays such as transmission delays or queuing delays that occurred inside the core network. In still yet further embodiments, the process 1200 may update the correction field based on an existing value of the correction field and a transmit timestamp of the timing packet from the egress network device. In an example where an ingress network device modified the correction field with a difference of a receive timestamp at the ingress network device and an original value of the correction field, the process 1200 may update the correction field with a value obtained by subtracting the existing value of the correction field from the transmit timestamp of the egress network device. In further examples the receive timestamp of the ingress network device may have been captured in a metadata in the timing packet. In such embodiments, the process 1200 may update the correction field by adding to the existing value of the correction field, a difference between the receive timestamp extracted from the metadata and the transmit timestamp of the egress network device.

In further embodiments, the process 1200 may determine a difference between an egress transmit timestamp and an ingress receive timestamp of the timing packet (block 1240). The egress transmit timestamp may refer to the exact time when the timing packet may be forwarded from a transmit port of the egress network device. The ingress receive timestamp may refer to the exact time when the timing packet may have been received by the ingress network device. Thus, the difference between the egress transmit timestamp and the ingress receive timestamp of the timing packet may be considered as the transit time of the timing packet traversing through the core network.

In still more embodiments, the process 1200 may compare the determined difference with an acceptable threshold range (block 1250). The process 1200 may compare the difference between the egress transmit timestamp and the ingress receive timestamp of the timing packet with the acceptable threshold range. In an example scenario, if the determined difference indicates a large time duration ranging in tens of minutes, it may indicate an error in the timing packet. In one or more embodiments, the acceptable threshold range may be indicated in metadata embedded in the timing packet.

In still further embodiments, the process 1200 may determine whether the determined difference is within the acceptable threshold range (block 1255). If the determined difference is within the acceptable threshold range, in still additional embodiments, the process 1200 may forward the timing packet at the egress transmit timestamp via the transmit port (block 1260).

However, in yet more embodiments, if the determined difference is not within the acceptable threshold range, the process 1200 may drop the timing packet (block 1270). The determined difference may be way less than the acceptable threshold range, thus indicating malicious timing packet originating from a source entity that may function close to the egress network device.

Although a specific embodiment showing a process for receiving a timing packet by an egress network device suitable for carrying out the various steps, processes, methods, and operations described herein is discussed with respect to FIG. 12, any of a variety of systems and/or processes may be utilized in accordance with embodiments of the disclosure. In yet more embodiments, if the difference between the egress transmit timestamp and the ingress receive timestamp of the timing packet exceeds the acceptable threshold range, the process 1200 may execute static or policy-defined actions for clock synchronization. In an example scenario, the process 1200 may trigger an alarm or notify network administrators about the out-of-range timing event. The elements depicted in FIG. 12 may also be interchangeable with other elements of FIGS. 1-11 and 13 as required to realize a particularly desired embodiment.

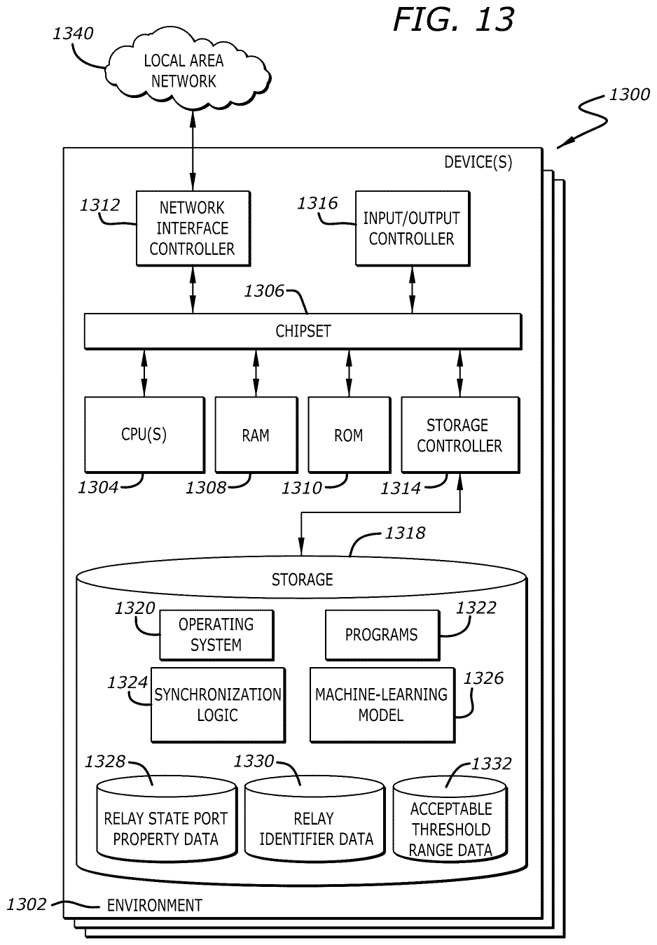

Referring to FIG. 13, a conceptual block diagram of a device 1300 suitable for configuration with a synchronization logic in accordance with various embodiments of the disclosure is shown. The embodiment of the conceptual block diagram depicted in FIG. 13 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 13 can also illustrate an access point, a switch, or a router in accordance with various embodiments of the disclosure. The device 1300 may, in many nonlimiting examples, correspond to physical devices or to virtual resources described herein.

In many embodiments, the device 1300 may include an environment 1302 such as a baseboard or “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In more embodiments, one or more processors 1304, such as, but not limited to, standard programmable central processing units (“CPUs”) can be configured to operate in conjunction with a chipset 1306. The processor(s) 1304 can be standard programmable CPUs that perform arithmetic and logical operations necessary for the operation of the device 1300.

In a number of embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1306 may provide an interface between the processor(s) 1304 and the remainder of the components and devices within the environment 1302. The chipset 1306 can provide an interface to a random-access memory (“RAM”) 1308, which can be used as the main memory in the device 1300 in some embodiments. The chipset 1306 can further be configured to provide an interface to a computer-readable storage medium such as a read-only memory (“ROM”) 1310 or non-volatile RAM (“NVRAM”) for storing basic routines that can help with various tasks such as, but not limited to, starting up the device 1300 and/or transferring information between the various components and devices. The ROM 1310 or NVRAM can also store other application components necessary for the operation of the device 1300 in accordance with various embodiments described herein.

Additional embodiments of the device 1300 can be configured to operate in a networked environment using logical connections to remote computing devices and computer systems through a network, such as the network 1340. The chipset 1306 can include functionality for providing network connectivity through a network interface controller (“NIC”) 1312, which may comprise a gigabit Ethernet adapter or similar component. The NIC 1312 can be capable of connecting the device 1300 to other devices over the network 1340. It is contemplated that multiple NICs 1312 may be present in the device 1300, connecting the device to other types of networks and remote systems.

In further embodiments, the device 1300 can be connected to a storage 1318 that provides non-volatile storage for data accessible by the device 1300. The storage 1318 can, for instance, store an operating system 1320, applications 1322, relay state port property data 1328, relay identifier data 1330, and acceptable threshold range data 1332 which are described in greater detail below. The storage 1318 can be connected to the environment 1302 through a storage controller 1314 connected to the chipset 1306. In certain embodiments, the storage 1318 can consist of one or more physical storage units. The storage controller 1314 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1300 can store data within the storage 1318 by transforming the physical state of the physical storage units to reflect the information being stored. The specific transformation of physical state can depend on various factors. Examples of such factors can include, but are not limited to, the technology used to implement the physical storage units, whether the storage 1318 is characterized as primary or secondary storage, and the like.

In many more embodiments, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to device 1300. Stated otherwise, some or all of the operations performed by the cloud computing network, and or any components included therein, may be performed by one or more devices 1300 operating in a cloud-based arrangement.

By way of example, and not limitation, computer-readable storage media can include volatile and non-volatile, removable and non-removable media implemented in any method or technology. Computer-readable storage media includes, but is not limited to, a RAM, a ROM, electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1318 can store an operating system 1320 utilized to control the operation of the device 1300. According to one embodiment, the operating system 1320 comprises the LINUX operating system. According to another embodiment, the operating system 1320 comprises the WINDOWS® SERVER operating system from MICROSOFT Corporation of Redmond, Washington. According to further embodiments, the operating system 1320 can comprise the UNIX operating system or one of its variants. It should be appreciated that other operating systems can also be utilized. The storage 1318 can store other system or application programs and data utilized by the device 1300.

In many additional embodiments, the storage 1318 or other computer-readable storage media is encoded with computer-executable instructions which, when loaded into the device 1300, may transform it from a general-purpose computing system into a special-purpose computer capable of implementing the embodiments described herein. These computer executable instructions may be stored as application 1322 and transform the device 1300 by specifying how the processor(s) 1304 can transition between states, as described above. In some embodiments, the device 1300 has access to computer-readable storage media storing computer executable instructions which, when executed by the device 1300, perform the various processes described above with regard to FIGS. 1-10. In certain embodiments, the device 1300 can also include computer-readable storage media having instructions stored thereupon for performing any of the other computer-implemented operations described herein.

In still further embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 might not include all of the components shown in FIG. 13 and can include other components that are not explicitly shown in FIG. 13 or might utilize an architecture completely different than that shown in FIG. 13.

As described above, the device 1300 may support a virtualization layer, such as one or more virtual resources executing on the device 1300. In some examples, the virtualization layer may be supported by a hypervisor that provides one or more virtual machines running on the device 1300 to perform functions described herein. The virtualization layer may generally support a virtual resource that performs at least a portion of the techniques described herein.

In many further embodiments, the device 1300 may include a synchronization logic 1324. The synchronization logic 1324 can be configured to perform one or more of the various steps, processes, operations, and/or other methods. Often, the synchronization logic 1324 can be a set of instructions stored within a non-volatile memory that, when executed by the processor(s)/controller(s) 1304 can carry out these steps, etc. In some embodiments, the synchronization logic 1324 may be a client application that resides on a network-connected device, such as, but not limited to, a server, switch, personal or mobile computing device in a single or distributed arrangement.

In various embodiments, the synchronization logic 1324 can be configured to perform one or more of the various steps, processes, operations, and/or other methods described above in conjunction with FIGS. 1-12 and can be configured to store various network compliance information, network security policies, threshold scores for monitoring user device behavior, or the like. The synchronization logic 1324 can be used to perform clock synchronization across a source device and a destination device, operational in different access networks, without involvement of a core network. The synchronization logic 1324 may perform stateless clock synchronization from one access network to another access network connected through a core network as described in the foregoing description of FIGS. 1-12.

In still more embodiments, the relay state port property data 1328 may refer to specific operational modes of a network device and may define whether the port should perform simple forwarding of timing packet or may discard a timing packet. If the relay state port property of a receive port of the device 1300 is enabled, the timing packet may be forwarded, else the device 1300 may discard the timing packet.

In still further embodiments, the relay identifier data 1330 stores information regarding source entity associated with timing packets or a source port that provided the timing packet to a receive port of the device 1300. The relay identifier data 1330 may refer to a unique identifier or marker within a timing packet that can be utilized to identify a network device (such as a switch, a router, an AP, or the like) that has forwarded or relayed the timing packet to the device 1300. In several embodiments, the device 1300 may store preset values for the relay identifier data 1330 indicating the network devices for which the forwarding of the timing packet may be enabled.

In still additional embodiments, the acceptable threshold range data 1332 may store information that defines a maximum time difference allowed between an ingress network device and an egress network device for the propagation of a timing packet. In an example scenario, if a determined difference between a transmit timestamp of the timing packet from the egress network device and a receive timestamp of the timing packet from the ingress network device, is within the acceptable threshold range data 1332, in several more embodiments, the device 1300 may permit forwarding of the timing packet, else the timing packet may be dropped.

Finally, in numerous additional embodiments, data may be processed into a format usable by a machine-learning model 1326 (e.g., feature vectors), and or other pre-processing techniques. The machine-learning (“ML”) model 1326 may be any type of ML model, such as supervised models, reinforcement models, and/or unsupervised models. The ML model 1326 may include one or more linear regression models, logistic regression models, decision trees, Naïve Bayes models, neural networks, k-means cluster models, random forest models, and/or other types of ML models 1326. In numerous embodiments, the ML model(s) 1326 can be utilized to predict which timing packets need to be forwarded based on relay identifier associated with the timing packet. The ML models 1326, thus may take a decision to forward or discard the timing packet, based on the relay identifier, indicating source entity, associated with the timing packet.

The ML model(s) 1326 can be configured to generate inferences to make predictions or draw conclusions from data. An inference can be considered the output of a process of applying a model to new data. This can occur by learning from at least the relay state port property data 1328, the relay identifier data 1330, and the acceptable threshold range data 1332 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1326 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An ingress network device, comprising:
a processor;
one or more receive ports;
one or more transmit ports; and
a memory communicatively coupled to the processor, wherein the memory comprises a synchronization logic that is configured to:
receive a timing packet at a receive port of the one or more receive ports;
capture, in the timing packet, a receive timestamp of receiving the timing packet;
add an encapsulation to the timing packet; and
forward the timing packet via a transmit port of the one or more transmit ports.

2. The ingress network device of claim 1, wherein the timing packet comprises a timing value and a correction field.

3. The ingress network device of claim 2, wherein capturing the receive timestamp in the timing packet comprises modifying an existing value of the correction field based on the receive timestamp.

4. The ingress network device of claim 3, wherein the existing value of the correction field is modified to indicate a difference of the receive timestamp and the existing value of the correction field.

5. The ingress network device of claim 3, wherein the receive timestamp is captured in the timing packet prior to encapsulating the timing packet.

6. The ingress network device of claim 1, wherein capturing the receive timestamp in the timing packet comprises assigning metadata to the timing packet, the metadata configured to indicate the receive timestamp.

7. The ingress network device of claim 6, wherein the metadata is further configured to indicate an acceptable threshold range that defines a maximum time difference allowed between the ingress network device and an egress network device.

8. The ingress network device of claim 1, wherein the receive port is associated with a relay state port property.

9. The ingress network device of claim 8, wherein the synchronization logic is further configured to determine whether the relay state port property is enabled.

10. The ingress network device of claim 9, wherein the timing packet is forwarded in response to determining that the relay state port property is enabled.

11. The ingress network device of claim 1, wherein the timing packet comprises a relay identifier that is configured to indicate at least one of a source entity associated with the timing packet or a source port that provided the timing packet to the receive port.

12. The ingress network device of claim 11, wherein the synchronization logic is further configured to determine whether the relay identifier has a preset value.

13. The ingress network device of claim 12, wherein the timing packet is forwarded in response to determining that the relay identifier has the preset value.

14. The ingress network device of claim 11, wherein the relay identifier is propagated as one of a part of the encapsulation or within a payload of the timing packet.

15. The ingress network device of claim 1, wherein the ingress network device corresponds to an ingress provider edge device in a core network.

16. An egress network device, comprising:
a processor;
one or more transmit ports; and
a memory communicatively coupled to the processor, wherein the memory comprises a synchronization logic that is configured to:
receive an encapsulated timing packet comprising a timing value and a correction field;
decapsulate the timing packet;
update the correction field based on an existing value of the correction field and a transmit timestamp of the timing packet from the egress network device; and
forward, at the transmit timestamp, the timing packet with the updated correction field via a transmit port of the one or more transmit ports.

17. The egress network device of claim 16, wherein the correction field is further updated based on a receive timestamp of the timing packet at an ingress network device.

18. The egress network device of claim 17, wherein the updated correction field is configured to indicate a timing delay associated with a core network that comprises the egress network device and the ingress network device.

19. The device of claim 17, wherein prior to forwarding the timing packet, the synchronization logic is further configured to:
determine a difference between the transmit timestamp and the receive timestamp;
compare the determined difference with an acceptable threshold range; and
permit forwarding of the timing packet based on the determined difference being within the acceptable threshold range.

20. A method for time synchronization, comprising:
receiving a timing packet at a receive port of an ingress network device;
capturing, in the timing packet, a receive timestamp of the timing packet at the receive port;
adding an encapsulation to the timing packet; and
transmitting the timing packet via a transmit port of the ingress network device.
